(19) United States
(12) Patent Application Publication
(10) Pub. No.: US 2002/0169735 A1
(43) Pub. Date: Nov. 14, 2002

(54) Automatic mapping from data to preprocessing algorithms

(76) Inventors: David Kil, Gilroy, CA (US); Andrew Bradley, Huntington Beach, CA (US)

Correspondence Address: Philip D. Segrest, Jr., Welsh & Katz, Ltd., 22nd Floor, 120 South Riverside Plaza, Chicago, IL, 60606, US

(21) Appl. No.: 09/945,530

(22) Filed: Aug. 3, 2001

Related U.S. Application Data
(60) Provisional application No. 60/274,008, filed on Mar. 7, 2001.

(51) Int. Cl. G06F 17/00

(52) U.S. Cl. 706/46

(57) ABSTRACT

One embodiment is a method to identify a preprocessing algorithm for raw data. The method may includes the steps of providing an algorithm knowledge database including preprocessing algorithm data and feature set data associated with the preprocessing algorithm data, analyzing raw data to produce analyzed data, extracting from the analyzed data features that characterize the data, and selecting a preprocessing algorithm using the algorithm knowledge database and features extracted from the analyzed data. Another embodiment is a data mining system for identifying a preprocessing algorithm for raw data using this method. Still another embodiment is a data mining application with improved preprocessing algorithm selection, including (a) an algorithm knowledge database containing preprocessing algorithm data and feature set data associated with the preprocessing algorithm data; (b) a data analysis module adapted to receive control of the data mining application when the data mining application begins; (c) a feature extraction module adapted to receive control of the data mining application from the data analysis module and available to identify a set of features; and (d) an algorithm selection module available to receive control from the feature extraction module and available to identify a preprocessing algorithm based upon the set of features identified by the feature extraction module using the algorithm knowledge database.

### CROSS-REFERENCE TO RELATED APPLICATIONS

This application claims the benefit of U.S. Provisional Application No. 60/274,008, filed Mar. 7,2001.

### STATEMENT REGARDING FEDERALLY SPONSORED RESEARCH

Part of the funding for research leading to this invention may have been provided under federal government contract number 30018-7115, “ONR Algorithm Toolbox Development.”

### REFERENCE TO COMPUTER PROGRAM LISTING APPENDIX

This application includes a computer program appendix listing (in compliance with 37 C.F.R. §1.96) containing source code for a prototype of an embodiment. The computer program appendix listing is submitted herewith on one original and one duplicate compact disc (in compliance with 37 C.F.R. §1.52(e)) designated respectively as Copy 1 and Copy 2 and labeled in compliance with 37 C.F.R. §1.52(e)(6).

All the material in this computer program appendix listing on compact disc is hereby incorporated herein by reference, and identified by the following table of file names, creation/modification date, and size in bytes:

| | CREATED/ | SIZES IN |
|---|---|---|
| NAMES OF FILES | MODIFIED | BYTES |
| DMS\date_convert.c | 18-Jun-01 | 12,557 |
| DMS\date_convert_mex.c | 18-Jun-01 | 6,971 |
| DMS\determine_field_type.c | 18-Jun-01 | 13,005 |
| DMS\determine_field_type_mex.c. | 18-Jun-01 | 4,061 |
| DMS\read_ascii_mix2.c | 18-Jun-01 | 41,256 |
| DMS\read_ascii_mix2_mex.c | 18-Jun-01 | 30,728 |
| DMS\read_palm.c | 18-Jun-01 | 20,553 |
| DMS\read_palm_mex.c | 18-Jun-01 | 12,332 |
| DMS\date_convert.h | 18-Jun-01 | 1,135 |
| DMS\datenum.h | 18-Jun-01 | 1,080 |
| DMS\determine_field_type.h | 18-Jun-01 | 1,076 |
| DMS\fgetl.h | 18-Jun-01 | 841 |
| DMS\find_break.h | 18-Jun-01 | 1,064 |
| DMS\find_date_field2.h | 18-Jun-01 | 1,024 |
| DMS\find_mos.h | 18-Jun-01 | 898 |
| DMS\isalpha.h | 18-Jun-01 | 859 |
| DMS\mod.h | 18-Jun-01 | 844 |
| DMS\read_ascii_mix2.h | 18-Jun-01 | 1,414 |
| DMS\read_palm.h | 18-Jun-01 | 1,300 |
| DMS\sec.h | 18-Jun-01 | 831 |
| DMS\std.h | 18-Jun-01 | 867 |
| DMS\str2num.h | 18-Jun-01 | 853 |
| DMS\strvcat.h | 18-Jun-01 | 884 |
| DMS\addonp.m | 26-Jun-01 | 6,013 |
| DMS\addonrp.m | 26-Jun-01 | 4,518 |
| DMS\adjust_barr.m | 17-May-01 | 373 |
| DMS\adjust_barrr.m | 17-May-01 | 377 |
| DMS\align_time.m | 19-Jun-01 | 373 |
| DMS\all_inf.m | 26-Jan-01 | 793 |
| DMS\arcovp.m | 25-Jun-01 | 797 |
| DMS\auto_input_select.m | 26-Jan-01 | 1,165 |
| DMS\auto_select_input.m | 2-Jul-01 | 1,711 |
| DMS\b_read.m | 18-Aug-00 | 4,813 |
| DMS\batch_kdd.m | 10-May-01 | 46,083 |
| DMS\batch_palm.m | 11-May-01 | 45,855 |
| DMS\binconv.m | 11-Jun-01 | 114 |
| DMS\blind_test.m | 12-Jun-01 | 4,778 |
| DMS\blindblind.m | 12-Jul-01 | 3,446 |
| DMS\bnn_act_bk.m | 6-Mar-01 | 10,800 |
| DMS\bvarr.m | 9-Jul-01 | 4,797 |
| DMS\candlestick.m | 24-Aug-00 | 177 |
| DMS\cat_string_field.m | 10-May-01 | 662 |
| DMS\catcell.m | 31-May-01 | 149 |
| DMS\cell2num.m | 1-Nov-99 | 447 |
| DMS\clas_discrete_combine.m | 26-Jun-01 | 5,487 |
| DMS\collagen.m | 14-Aug-00 | 2,693 |
| DMS\compile_results.m | 23-Apr-01 | 5,478 |
| DMS\compile_results_m.m | 23-Apr-01 | 4,915 |
| DMS\concatstr.m | 4-Jun-01 | 108 |
| DMS\convert_wk2mo.m | 11-May-01 | 755 |
| DMS\convertAtoB.m | 21-May-01 | 684 |
| DMS\convertYmd2Date.m | 19-Jun-01 | 332 |
| DMS\corr_coeff.m | 26-Jan-01 | 1,168 |
| DMS\corr_rank.m | 16-Jun-01 | 316 |
| DMS\create_thrombo_metadata.m | 17-May-01 | 1,517 |
| DMS\csv2strv.m | 16-May-01 | 341 |
| DMS\ctb_hist2.m | 24-May-01 | 2,179 |
| DMS\dataload.m | 23-Apr-01 | 7,962 |
| DMS\dataload_m.m | 23-Apr-01 | 7,810 |
| DMS\dataload2.m | 26-Jan-01 | 2,056 |
| DMS\dataload2_m.m | 26-Jan-01 | 2,403 |
| DMS\date_convert.m | 18-Jun-01 | 519 |
| DMS\date_display.m | 12-Aug-00 | 150 |
| DMS\date_interval.m | 12-Jun-01 | 556 |
| DMS\DCT_feat.m | 11-Jun-01 | 452 |
| DMS\decimate_scatter.m | 30-May-01 | 1,648 |
| DMS\decode_answer.m | 16-Jun-01 | 218 |
| DMS\delete_figures.m | 23-Apr-01 | 1,086 |
| DMS\detailed_results.m | 10-May-01 | 4,990 |
| DMS\determine_catord.m | 20-Sep-00 | 249 |
| DMS\determine_field_type.m | 2-Jul-01 | 931 |
| DMS\deunderscore.m | 27-May-01 | 175 |
| DMS\dimension_reduction.m | 11-Jun-01 | 1,525 |
| DMS\dimension_reductionS.m | 7-Jun-01 | 1,402 |
| DMS\display_example.m | 10-May-01 | 260 |
| DMS\dm_batch.m | 30-Jun-01 | 2,866 |
| DMS\dm_expert.m | 11-May-01 | 191 |
| DMS\dm_expert_gui.m | 12-Jul-01 | 11,194 |
| DMS\dm_expert_part.m | 12-May-01 | 1,716 |
| DMS\dm_expert_run.m | 12-Jul-01 | 8,208 |
| DMS\DM_recommend.m | 8-Jun-01 | 4,718 |
| DMS\dmr_expert_gui.m | 22-Jun-01 | 8,360 |
| DMS\dmr_expert_part.m | 29-Jun-01 | 2,736 |
| DMS\dmr_expert_run.m | 2-Jul-01 | 7,441 |
| DMS\dms_dataload.m | 23-Apr-01 | 317 |
| DMS\dms_demo.m | 23-Apr-01 | 1,975 |
| DMS\dms_main.m | 26-Jun-01 | 6,159 |
| DMS\dms_params.m | 12-Jul-01 | 4,048 |
| DMS\DWT.m | 16-Jun-01 | 578 |
| DMS\elim_article.m | 29-Jan-01 | 586 |
| DMS\embed_sm.m | 10-Nov-00 | 282 |
| DMS\embed_smooth.m | 21-May-01 | 205 |
| DMS\enco.m | 19-Feb-01 | 350 |
| DMS\energy_compact.m | 5-Jun-01 | 822 |
| DMS\exl_getmat.m | 1-Nov-99 | 2,681 |
| DMS\exl_setmat.m | 1-Nov-99 | 4,084 |
| DMS\explain_candle.m | 28-Aug-00 | 716 |
| DMS\explain_llr.m | 23-Apr-01 | 533 |
| DMS\explain_oc.m | 23-Apr-01 | 413 |
| DMS\explain_pdf.m | 28-Aug-00 | 413 |
| DMS\explain_pfi.m | 23-Apr-01 | 641 |
| DMS\explain_scat.m | 28-Aug-00 | 454 |
| DMS\explore_macro.m | 22-Jun-01 | 2,551 |
| DMS\explore_ts.m | 22-Jun-01 | 2,141 |
| DMS\explore1D.m | 26-Jun-01 | 6,058 |
| DMS\extract_time_feat.m | 29-Jun-01 | 1,171 |
| DMS\feature_rank.m | 11-Jun-01 | 464 |
| DMS\find_break.m | 14-Jun-01 | 537 |
| DMS\find_comma.m | 19-Jun-01 | 380 |
| DMS\find_date_field.m | 15-Jun-01 | 151 |
| DMS\find_date_field2.m | 20-Jun-01 | 248 |
| DMS\find_drug_feat.m | 14-Aug-00 | 918 |
| DMS\find_drug_feat2.m | 26-Aug-00 | 1,019 |
| DMS\find_field.m | 26-Jun-01 | 3,235 |
| DMS\find_future.m | 29-Jun-01 | 121 |
| DMS\find_ip.m | 15-May-01 | 321 |
| DMS\find_mos.m | 20-Jun-01 | 203 |
| DMS\find_var_zero.m | 26-Jun-01 | 286 |
| DMS\fm_clean.m | 25-Aug-00 | 1,129 |
| DMS\fm_prep.m | 26-Aug-00 | 153 |
| DMS\formatTime.m | 19-Jun-01 | 586 |
| DMS\frank_rank.m | 31-May-01 | 270 |
| DMS\FromGT.m | 4-Jun-01 | 240 |
| DMS\FromInput1.m | 9-May-01 | 54 |
| DMS\FromInput2.m | 16-Jun-01 | 298 |
| DMS\FromOutput.m | 16-Jun-01 | 377 |
| DMS\FromSegment.m | 25-May-01 | 270 |
| DMS\FromSegment2.m | 18-Jun-01 | 248 |
| DMS\FromTime.m | 13-Jun-01 | 159 |
| DMS\gen_dcrm.m | 13-Jun-01 | 1,366 |
| DMS\gen_dcrm2.m | 13-Jun-01 | 1,382 |
| DMS\gen_dcrm3.m | 14-Jun-01 | 912 |
| DMS\gen_mog_metadata.m | 21-May-01 | 283 |
| DMS\generate_lift_pdf.m | 12-Jun-01 | 2,379 |
| DMS\genPalmTS.m | 19-Jun-01 | 1,748 |
| DMS\get_boundary.m | 6-Jun-01 | 635 |
| DMS\get_metadata.m | 12-Jul-01 | 8,730 |
| DMS\ginput_proc.m | 19-Jun-01 | 271 |
| DMS\glm_act_bk.m | 6-Mar-01 | 0 |
| DMS\global_var.m | 11-May-01 | 841 |
| DMS\gmm_act_bk.m | 6-Mar-01 | 11,021 |
| DMS\ground_truth.m | 4-Jun-01 | 1,597 |
| DMS\gt_process1.m | 4-Jun-01 | 1,085 |
| DMS\gt_show_choice.m | 4-Jun-01 | 538 |
| DMS\gt_truth.m | 4-Jun-01 | 1,697 |
| DMS\input_help.m | 23-Apr-01 | 3,153 |
| DMS\input_help_m.m | 24-Apr-01 | 4,536 |
| DMS\insert2Time.m | 19-Jun-01 | 704 |
| DMS\io_help.m | 24-Jun-01 | 4,404 |
| DMS\k_errorbar.m | 25-Aug-00 | 3,400 |
| DMS\kdd_sysparam.m | 26-Aug-00 | 328 |
| DMS\knn_act_bk.m | 6-Mar-01 | 11,314 |
| DMS\ks_regress.m | 20-Jun-01 | 322 |
| DMS\lala_redux.m | 11-Jun-01 | 1,590 |
| DMS\lfc_act_bk.m | 6-Mar-01 | 10,641 |
| DMS\lp_predict.m | 25-Jun-01 | 439 |
| DMS\lp_predict_bt.m | 26-Jun-01 | 556 |
| DMS\lp_predict2.m | 25-Jun-01 | 237 |
| DMS\lpc_pred.m | 26-Jun-01 | 339 |
| DMS\lsvm.m | 27-Jun-01 | 518 |
| DMS\main_kdd2001.m | 6-Jun-01 | 145 |
| DMS\main_palm.m | 27-May-01 | 294 |
| DMS\main_uci.m | 5-Jun-01 | 17,394 |
| DMS\makeiteven.m | 23-Aug-00 | 757 |
| DMS\master_homeeq.m | 26-Jan-01 | 1,926 |
| DMS\master_homeew.m | 26-Jan-01 | 1,847 |
| DMS\master_kdd.m | 20-Feb-01 | 2,100 |
| DMS\master_mail.m | 26-Jan-01 | 1,929 |
| DMS\max_matrix.m | 27-Aug-00 | 164 |
| DMS\max_matrixr.m | 31-May-01 | 323 |
| DMS\mean_ks.m | 14-Jun-01 | 59 |
| DMS\median_norm.m | 4-Jun-01 | 497 |
| DMS\merge_clas.m | 6-Jun-01 | 427 |
| DMS\merge_tables.m | 29-Nov-00 | 6,357 |
| DMS\metadata_list.m | 20-Jun-01 | 2,050 |
| DMS\mlp_act_bk.m | 6-Mar-01 | 10,650 |
| DMS\mm_kdd.m | 24-Jan-01 | 624 |
| DMS\mom_rank.m | 29-May-01 | 507 |
| DMS\more_results.m | 10-May-01 | 5,111 |
| DMS\more_results_r2.m | 20-Jun-01 | 3,450 |
| DMS\more_results2.m | 20-Jun-01 | 3,259 |
| DMS\mssk_est.m | 5-Jun-01 | 417 |
| DMS\msskk.m | 5-Jun-01 | 941 |
| DMS\multi_table.m | 18-Aug-00 | 2,634 |
| DMS\mvg_act_bk.m | 11-May-01 | 12,357 |
| DMS\nnc_act_bk.m | 6-Mar-01 | 10,690 |
| DMS\norm_reg.m | 31-May-01 | 298 |
| DMS\one_inb.m | 26-Jan-01 | 552 |
| DMS\one_inf.m | 29-Aug-00 | 1,690 |
| DMS\one_inf_m.m | 20-Sep-00 | 696 |
| DMS\one_outb.m | 22-Aug-00 | 571 |
| DMS\one_outf.m | 19-Aug-00 | 1,221 |
| DMS\one_outf_m.m | 20-Sep-00 | 493 |
| DMS\outlier_det.m | 28-May-01 | 567 |
| DMS\outlier_det_pert.m | 30-May-01 | 817 |
| DMS\own_process.m | 24-Jun-01 | 728 |
| DMS\palm_customer_mapping.m | 15-Jun-01 | 326 |
| DMS\Palm_customer_match.m | 18-Jun-01 | 1,264 |
| DMS\palm_derive_fields.m | 20-Jun-01 | 2,539 |
| DMS\palm_events.m | 12-Jun-01 | 2,359 |
| DMS\Palm_product_sales.m | 17-Jun-01 | 626 |
| DMS\palm_time_series_fields.m | 15-Jun-01 | 1,233 |
| DMS\palm_time_series_fields2.m | 18-Jun-01 | 2,114 |
| DMS\PalmAllS_postprocess.m | 19-Jun-01 | 322 |
| DMS\PC_tradeoff.m | 5-Jun-01 | 594 |
| DMS\pca_feat.m | 21-May-01 | 158 |
| DMS\pfapd.m | 29-Aug-00 | 384 |
| DMS\pl_fx.m | 22-Aug-00 | 354 |
| DMS\pl_reset.m | 22-Aug-00 | 81 |
| DMS\pl_run.m | 22-Aug-00 | 1,414 |
| DMS\pl_zoom.m | 22-Aug-00 | 1,218 |
| DMS\playwithfm.m | 22-Aug-00 | 2,505 |
| DMS\plot_time_series.m | 19-Jun-01 | 4,156 |
| DMS\pnn_act_bk.m | 6-Mar-01 | 11,124 |
| DMS\prep_dm.m | 20-Sep-00 | 129 |
| DMS\prep_macro_econ.m | 11-May-01 | 1,230 |
| DMS\prepare_data2.m | 24-Jan-01 | 5,185 |
| DMS\prepare_data3.m | 12-Jul-01 | 5,249 |
| DMS\rbf_act_bk.m | 6-Mar-01 | 10,716 |
| DMS\read_ascii_mix.m | 15-Jun-01 | 2,393 |
| DMS\read_ascii_mix2.m | 21-Jun-01 | 3,316 |
| DMS\read_ascii_mix3.m | 16-Jun-01 | 2,524 |
| DMS\read_ascii_mix5.m | 18-Jun-01 | 2,479 |
| DMS\read_fred_mos.m | 10-May-01 | 845 |
| DMS\read_free_wkly.m | 10-May-01 | 1,133 |
| DMS\read_mailing.m | 20-Sep-00 | 364 |
| DMS\read_names.m | 5-Jun-01 | 253 |
| DMS\read_palm.m | 18-Jun-01 | 1,269 |
| DMS\read_time_samples.m | 23-Apr-01 | 6,413 |
| DMS\read_uci.m | 24-May-01 | 816 |
| DMS\read_yeast.m | 21-Jun-01 | 171 |
| DMS\remove_outlier.m | 27-Aug-00 | 345 |
| DMS\reset_inout.m | 29-Nov-00 | 223 |
| DMS\reset_io.m | 22-Jun-01 | 513 |
| DMS\resetTime.m | 13-Jun-01 | 66 |
| DMS\resolve_customer_ambiguity.m | 18-Jun-01 | 731 |
| DMS\run_dm.m | 2-Jul-01 | 1,336 |
| DMS\run_dm_master.m | 31-May-01 | 348 |
| DMS\run_now.m | 28-Aug-00 | 639 |
| DMS\saveTime.m | 19-Jun-01 | 458 |
| DMS\select_input_m.m | 23-Apr-01 | 428 |
| DMS\setdiff_unsort.m | 17-May-01 | 220 |
| DMS\show_croc.m | 21-May-01 | 381 |
| DMS\show_or_hide.m | 11-May-01 | 249 |
| DMS\show_or_hide_reg.m | 31-May-01 | 255 |
| DMS\show_pdfns.m | 21-May-01 | 446 |
| DMS\show_percentile.m | 14-Jun-01 | 463 |
| DMS\showfeat.m | 10-May-01 | 3,259 |
| DMS\showfeatPDF.m | 20-Jun-01 | 4,658 |
| DMS\showfeatPDFr.m | 16-Jun-01 | 1,267 |
| DMS\sort_str.m | 1-Jun-01 | 424 |
| DMS\str2datenum.m | 27-May-01 | 204 |
| DMS\str2strs.m | 8-May-01 | 1,130 |
| DMS\strchop.m | 10-May-01 | 190 |
| DMS\strmatchfuzz.m | 4-Jun-01 | 564 |
| DMS\strmf.m | 10-May-01 | 716 |
| DMS\strvcmp.m | 10-May-01 | 271 |
| DMS\subgroup_segment.m | 20-Jun-01 | 1,702 |
| DMS\svd_fill_missing.m | 24-May-01 | 1,019 |
| DMS\svd_helpm.m | 1-Jun-01 | 112 |
| DMS\svd_te_helpm.m | 1-Jun-01 | 195 |
| DMS\svd_ter.m | 1-Jun-01 | 2,328 |
| DMS\svm_act_bk.m | 6-Mar-01 | 11,003 |
| DMS\TBFVE.m | 25-Jun-01 | 925 |
| DMS\test_bvar.m | 10-Jul-01 | 555 |
| DMS\test_lsvm.m | 27-Jun-01 | 413 |
| DMS\test_makeiteven.m | 23-Aug-00 | 166 |
| DMS\test_own.m | 24-Jun-01 | 140 |
| DMS\test_svd_te_help.m | 1-Jun-01 | 353 |
| DMS\testBlind.m | 12-Jul-01 | 1,309 |
| DMS\time_fe.m | 11-Jun-01 | 844 |
| DMS\time_feat_ext.m | 22-Jun-01 | 1,191 |
| DMS\time_gui.m | 19-Jun-01 | 3,590 |
| DMS\ToGT.m | 4-Jun-01 | 897 |
| DMS\ToInput1.m | 2-Jul-01 | 450 |
| DMS\ToInput2.m | 19-Jun-01 | 450 |
| DMS\ToOutput.m | 29-Jun-01 | 2,379 |
| DMS\ToSegment.m | 5-Jul-01 | 1,661 |
| DMS\ToTime.m | 13-Jun-01 | 111 |
| DMS\vq_trend.m | 15-May-01 | 437 |
| DMS\where_is_the_beef2.m | 12-Jul-01 | 3,432 |
| DMS\where_is_the_beefr2.m | 25-Jun-01 | 3,134 |
| DMS\why_selection.m | 1-Jun-01 | 2,324 |
| DMS\whyr_selection.m | 31-May-01 | 752 |
| DMS\zeropad.m | 24-Jun-01 | 388 |
| DMS\zoomks.m | 12-Aug-00 | 14,211 |
| DMS\zoomrot.m | 21-May-01 | 803 |
| DMS\README.txt | 13-Jul-01 | 429 |
| DSP\dsp.m | 12-Jul-01 | 12,272 |
| DSP\dsperror.m | 22-Jun-00 | 1,842 |
| DSP\dspfeature.m | 5-Jul-00 | 4,225 |
| DSP\dspgui.m | 12-Jul-01 | 31,515 |
| DSP\dsplo.m | 12-Jul-01 | 1,291 |
| DSP\EIH.m | 5-Jul-00 | 4,021 |
| DSP\err.m | 22-Jun-00 | 580 |
| DSP\feature_vis.m | 4-Jul-00 | 3,248 |
| DSP\fieldsave.m | 28-Jun-00 | 1,607 |
| DSP\fieldsave_fig.m | 5-Jul-00 | 2,240 |
| DSP\fieldsel.m | 4-Jul-00 | 1,423 |
| DSP\fieldsel_fig.m | 5-Jul-00 | 2,746 |
| DSP\fmsel.m | 5-Jul-00 | 3,621 |
| DSP\fmsel_fig.m | 5-Jul-00 | 10,234 |
| DSP\phasemap.m | 5-Jul-00 | 1,545 |
| DSP\spec_menu.m | 12-Jul-01 | 2,674 |
| DSP\status.m | 12-Jul-01 | 353 |
| DSP\test.m | 5-Jul-00 | 268 |
| DSP\tfr_menu.m | 12-Jul-01 | 9,958 |
| DSP\Tfrcw_m.m | 22-Jun-00 | 4,464 |
| DSP\TFRSTFT_m.M | 22-Jun-00 | 2,759 |
| IPARP\README | 23-Jun-94 | 838 |
| IPARP\addResiduals.c | 26-Jul-01 | 21,359 |
| IPARP\addResiduals_mex.c | 26-Jul-01 | 1,233 |
| IPARP\addResidualsC.c | 19-Feb-01 | 3,755 |
| IPARP\AMEBSA.C | 21-Feb-98 | 4,835 |
| IPARP\AMOTSA.C | 19-Feb-98 | 842 |
| IPARP\ann.c | 7-Dec-97 | 6,218 |
| IPARP\avq_test.c | 15-Apr-99 | 2,715 |
| IPARP\find_neighbor.c | 15-Apr-99 | 789 |
| IPARP\fm_norm.c | 15-Jul-99 | 647 |
| IPARP\hist_nbn.c | 15-Jan-01 | 1,507 |
| IPARP\histc.c | 15-Apr-99 | 1,246 |
| IPARP\knn.c | 16-Feb-01 | 14,412 |
| IPARP\knn_mex.c | 16-Feb-01 | 3,740 |
| IPARP\lumc.c | 15-Apr-99 | 2,509 |
| IPARP\martEval.c | 26-Jul-01 | 8,231 |
| IPARP\martEval_mex.c | 26-Jul-01 | 5,693 |
| IPARP\martEvalC.c | 21-Feb-01 | 5,010 |
| IPARP\mdc.c | 15-Apr-99 | 2,149 |
| IPARP\mlp.c | 16-Feb-01 | 16,484 |
| IPARP\mlp_mex.c | 16-Feb-01 | 3,751 |
| IPARP\mlregr.c | 20-Jun-01 | 17,050 |
| IPARP\mlregr_mex.c | 20-Jun-01 | 6,208 |
| IPARP\neighbor_share.c | 13-Jul-99 | 1,393 |
| IPARP\nnc.c | 19-Oct-00 | 2,372 |
| IPARP\nominalSplitC.c | 20-Feb-01 | 3,842 |
| IPARP\nominalSplitC_mex.c | 26-Jul-01 | 1,378 |
| IPARP\nominalSplitC_mex_interface.c | 26-Jul-01 | 5,361 |
| IPARP\Numcat.c | 13-Dec-98 | 28,979 |
| IPARP\numericSplitC.c | 20-Feb-01 | 2,597 |
| IPARP\obj_finder.c | 15-Apr-99 | 1,072 |
| IPARP\pnn.c | 15-Apr-99 | 2,861 |
| IPARP\pnn2.c | 17-Oct-00 | 2,785 |
| IPARP\pnn3.c | 17-Oct-00 | 2,826 |
| IPARP\RAN1.C | 19-Feb-98 | 896 |
| IPARP\RANDOM.C | 31-Mar-98 | 2,476 |
| IPARP\ranord.c | 15-Apr-99 | 943 |
| IPARP\rbf.c | 16-Feb-01 | 12,762 |
| IPARP\rbf_mex.c | 16-Feb-01 | 3,864 |
| IPARP\Relax.c | 30-Mar-98 | 9,089 |
| IPARP\Replace.c | 18-Jul-98 | 16,348 |
| IPARP\setValuesFromResiduals.c | 26-Jul-01 | 12,710 |
| IPARP\setValuesFromResiduals_mex.c | 26-Jul-01 | 3,947 |
| IPARP\setValuesFromResidualsC.c | 19-Feb-01 | 3,772 |
| IPARP\squash.c | 18-Jul-98 | 3,665 |
| IPARP\StateSpace.c | 24-Nov-98 | 19,359 |
| IPARP\StateSpace_.c | 18-Jul-98 | 21,924 |
| IPARP\Stats.c | 24-Nov-98 | 4,320 |
| IPARP\STwrite.c | 21-Sep-98 | 2,228 |
| IPARP\svd_te.c | 21-Jun-01 | 22,312 |
| IPARP\svd_te_help.c | 14-Jul-99 | 1,100 |
| IPARP\svd_te_mex.c | 21-Jun-01 | 15,512 |
| IPARP\Tred2.c | 22-Feb-98 | 3,562 |
| IPARP\Trimsmpl.c | 24-Nov-98 | 3,410 |
| IPARP\Util.c | 24-Nov-98 | 11,359 |
| IPARP\vq.c | 25-Aug-99 | 12,414 |
| IPARP\vqi.c | 30-Oct-00 | 12,101 |
| IPARP\WrtCC.c | 24-Nov-98 | 3,369 |
| IPARP\WrtParms.c | 19-Jul-98 | 4,467 |
| IPARP\WrtPIE.c | 24-Nov-98 | 4,398 |
| IPARP\WrtPrep.c | 24-Nov-98 | 11,353 |
| IPARP\WrtStat.c | 24-Nov-98 | 2,173 |
| IPARP\addResiduals.h | 26-Jul-01 | 1,142 |
| IPARP\determine_field_type.h | 21-Jun-01 | 1,073 |
| IPARP\dist2.h | 16-Feb-01 | 846 |
| IPARP\Dp.h | 24-Nov-98 | 15,666 |
| IPARP\isstruct.h | 16-Feb-01 | 854 |
| IPARP\knn.h | 16-Feb-01 | 945 |
| IPARP\martEval.h | 26-Jul-01 | 966 |
| IPARP\martEvalC_mex_interface.h | 26-Jul-01 | 1,175 |
| IPARP\mean.h | 21-Jun-01 | 844 |
| IPARP\median.h | 26-Jul-01 | 874 |
| IPARP\mlp.h | 16-Feb-01 | 1,030 |
| IPARP\mlregr.h | 20-Jun-01 | 1,163 |
| IPARP\nominalSplitC_mex_interface.h | 26-Jul-01 | 1,300 |
| IPARP\NRUTIL.H | 7-Dec-96 | 3,431 |
| IPARP\rbf.h | 16-Feb-01 | 947 |
| IPARP\rbfunpak.h | 16-Feb-01 | 872 |
| IPARP\setValuesFromResiduals.h | 26-Jul-01 | 1,224 |
| IPARP\svd_te.h | 21-Jun-01 | 1,161 |
| IPARP\svd_te_help.h | 21-Jun-01 | 988 |
| IPARP\svd_te_helpm.h | 21-Jun-01 | 1,001 |
| IPARP\trace.h | 21-Jun-01 | 836 |
| IPARP\access2fm.m | 25-May-01 | 881 |
| IPARP\ACTIVLEV.M | 12-May-98 | 6,174 |
| IPARP\addon.m | 26-Jul-01 | 5,992 |
| IPARP\addon_b.m | 19-Oct-00 | 4,436 |
| IPARP\addon_j1.m | 19-Oct-00 | 2,308 |
| IPARP\addonr.m | 3-Apr-01 | 4,604 |
| IPARP\addResiduals.m | 16-Feb-01 | 1,070 |
| IPARP\adjustkl.m | 13-Jul-99 | 1,255 |
| IPARP\amp_stat.m | 13-Jul-99 | 1,314 |
| IPARP\arbshow.m | 12-Dec-00 | 3,614 |
| IPARP\assign_tgt.m | 25-Apr-01 | 4,870 |
| IPARP\auvq.m | 12-Jul-99 | 4,348 |
| IPARP\averageNodeOutput.m | 21-Feb-01 | 272 |
| IPARP\avq.m | 19-Oct-00 | 5,228 |
| IPARP\avq_act.m | 6-Mar-01 | 12,439 |
| IPARP\avq_dlg.m | 19-Oct-00 | 3,343 |
| IPARP\b10to2.m | 23-Jun-94 | 941 |
| IPARP\backward.m | 14-Jul-99 | 1,194 |
| IPARP\barxy.m | 6-Dec-00 | 7,551 |
| IPARP\batch_dlg.m | 3-Sep-99 | 1,487 |
| IPARP\batch2_dlg.m | 19-Oct-00 | 30,339 |
| IPARP\batta.m | 19-Oct-00 | 2,228 |
| IPARP\Betap.m | 2-Aug-98 | 470 |
| IPARP\Betaq.m | 2-Aug-98 | 920 |
| IPARP\Betar.m | 2-Aug-98 | 366 |
| IPARP\Binomp.m | 28-Jul-99 | 497 |
| IPARP\Binomr.m | 28-Jul-99 | 390 |
| IPARP\bn_infer.m | 16-May-00 | 1,082 |
| IPARP\bn_train.m | 16-May-00 | 1,948 |
| IPARP\bnc_after_infer.m | 1-Jun-00 | 938 |
| IPARP\bnc_infer.m | 12-Jun-00 | 833 |
| IPARP\bnc_process.m | 12-Jun-00 | 1,925 |
| IPARP\bnc_run_infer.m | 1-Jun-00 | 1,141 |
| IPARP\bnc_train.m | 19-May-00 | 1,625 |
| IPARP\bnc_train2.m | 31-May-00 | 1,515 |
| IPARP\bncm_infer.m | 12-Jun-00 | 1,549 |
| IPARP\bncm_process.m | 12-Jun-00 | 667 |
| IPARP\bnd_infer.m | 12-Jun-00 | 1,119 |
| IPARP\bnd_process.m | 20-Jun-00 | 2,524 |
| IPARP\bnd_run_infer.m | 12-Jun-00 | 1,510 |
| IPARP\bndm_infer.m | 12-Jun-00 | 2,075 |
| IPARP\bndm_process.m | 12-Jun-00 | 517 |
| IPARP\bnh_after_infer.m | 12-Jun-00 | 1,326 |
| IPARP\bnh_infer.m | 12-Jun-00 | 986 |
| IPARP\bnh_process.m | 25-Jul-00 | 2,629 |
| IPARP\bnh_run_infer.m | 25-Jul-00 | 1,510 |
| IPARP\bnh_train.m | 6-Mar-01 | 4,508 |
| IPARP\bnh_train2.m | 30-May-00 | 862 |
| IPARP\bnhm_infer.m | 12-Jun-00 | 1,942 |
| IPARP\bnhm_process.m | 12-Jun-00 | 620 |
| IPARP\bnn.m | 19-Oct-00 | 3,597 |
| IPARP\bnn_act.m | 6-Mar-01 | 12,792 |
| IPARP\bnn_act_b.m | 6-Mar-01 | 10,754 |
| IPARP\bnn_act_hpc.m | 19-Oct-00 | 9,687 |
| IPARP\bnn_actg.m | 20-Feb-01 | 4,037 |
| IPARP\bnn_dlg.m | 20-Feb-01 | 3,947 |
| IPARP\bnn_dlgg.m | 20-Feb-01 | 3,146 |
| IPARP\bnn_dlgs.m | 23-Oct-00 | 4,491 |
| IPARP\bnng_body.m | 6-Mar-01 | 8,058 |
| IPARP\BNT_ui.m | 25-Jul-00 | 2,234 |
| IPARP\bpn.m | 19-Oct-00 | 1,973 |
| IPARP\bpn_act.m | 19-Oct-00 | 10,325 |
| IPARP\bpn_dlg.m | 19-May-99 | 2,295 |
| IPARP\brn.m | 18-May-01 | 913 |
| IPARP\brn_act.m | 28-Mar-01 | 12,659 |
| IPARP\brn_dlg.m | 28-Mar-01 | 3,773 |
| IPARP\brn_pr_act.m | 28-Mar-01 | 7,700 |
| IPARP\brn_pr_dlg.m | 28-Mar-01 | 3,758 |
| IPARP\brnr.m | 28-Mar-01 | 541 |
| IPARP\cartPredict.m | 21-Feb-01 | 1,154 |
| IPARP\cdd.m | 25-Jan-01 | 445 |
| IPARP\cddd.m | 25-Jan-01 | 737 |
| IPARP\cell2num.m | 1-Nov-99 | 447 |
| IPARP\celldisp.m | 15-May-00 | 1,378 |
| IPARP\celldisp2.m | 15-May-00 | 1,469 |
| IPARP\class_fuse.m | 6-Mar-01 | 2,314 |
| IPARP\class_partition.m | 19-Oct-00 | 3,369 |
| IPARP\cluster_merge.m | 9-Jul-98 | 1,032 |
| IPARP\cluster_test.m | 26-Oct-00 | 1,449 |
| IPARP\cmsort.m | 12-May-98 | 2,843 |
| IPARP\coh.m | 2-Apr-01 | 1,778 |
| IPARP\compare_CR.m | 10-Jun-99 | 1,704 |
| IPARP\compJ.m | 19-Oct-00 | 2,081 |
| IPARP\compJM.m | 19-Oct-00 | 2,961 |
| IPARP\compLL.m | 19-Oct-00 | 1,915 |
| IPARP\compO.m | 12-Jul-99 | 1,376 |
| IPARP\cont_disc.m | 27-Mar-01 | 297 |
| IPARP\cont_or_disc.m | 27-Mar-01 | 297 |
| IPARP\Contents.m | 9-Dec-99 | 2,945 |
| IPARP\corr.m | 2-Apr-01 | 2,460 |
| IPARP\corr1d.m | 14-Aug-00 | 1,091 |
| IPARP\CPDdisp.m | 1-Jun-00 | 1,176 |
| IPARP\cpdf.m | 12-Jul-99 | 1,241 |
| IPARP\CPDh_disp.m | 2-Jun-00 | 1,337 |
| IPARP\CPTdisp.m | 1-Jun-00 | 1,729 |
| IPARP\crlb_body.m | 9-Jul-98 | 4,963 |
| IPARP\ctb_histc.m | 16-Apr-01 | 2,424 |
| IPARP\dann_act.m | 26-Jul-01 | 12,671 |
| IPARP\dann_actg.m | 26-Jul-01 | 3,786 |
| IPARP\dann_dlg.m | 26-Jul-01 | 3,552 |
| IPARP\dann_dlgg.m | 26-Jul-01 | 2,758 |
| IPARP\danng_body.m | 26-Jul-01 | 8,054 |
| IPARP\datgen.m | 19-Oct-00 | 1,742 |
| IPARP\dbnd_run_infer.m | 22-Jun-00 | 1,511 |
| IPARP\decode.m | 23-Jun-94 | 853 |
| IPARP\derivs.m | 2-May-97 | 410 |
| IPARP\determine_data_type.m | 2-May-01 | 869 |
| IPARP\disc_disc_assoc.m | 7-Mar-01 | 381 |
| IPARP\disp_field_name.m | 2-May-01 | 336 |
| IPARP\disp_tree.m | 2-Feb-01 | 1,332 |
| IPARP\display_data_misc.m | 16-Oct-00 | 1,804 |
| IPARP\display_rank.m | 26-Feb-01 | 282 |
| IPARP\diverg.m | 19-Oct-00 | 2,573 |
| IPARP\dlmhdrload.m | 22-Jan-01 | 1,420 |
| IPARP\dmult.m | 2-May-97 | 123 |
| IPARP\doCPD.m | 25-Jul-00 | 1,590 |
| IPARP\doCPDh.m | 25-Jul-00 | 2,190 |
| IPARP\done_tgt.m | 7-Mar-01 | 1,649 |
| IPARP\dyadic.m | 20-Mar-01 | 202 |
| IPARP\em_act.m | 19-Oct-00 | 5,111 |
| IPARP\em_dlg.m | 1-Sep-99 | 2,817 |
| IPARP\em_new_dlg.m | 12-Jul-99 | 1,826 |
| IPARP\em_vq.m | 12-Jul-99 | 2,328 |
| IPARP\embed.m | 21-Dec-00 | 1,557 |
| IPARP\embed_sm.m | 1-Mar-01 | 323 |
| IPARP\embed_smooth.m | 24-Jul-01 | 205 |
| IPARP\entropy.m | 7-Mar-01 | 263 |
| IPARP\epic_act.m | 1-Sep-99 | 3,436 |
| IPARP\epic_eval.m | 1-Sep-99 | 3,193 |
| IPARP\epwic_act.m | 1-Sep-99 | 3,157 |
| IPARP\epwic_act2.m | 1-Sep-99 | 3,527 |
| IPARP\epwic_eval.m | 1-Sep-99 | 3,185 |
| IPARP\est_mean_freq.m | 20-Apr-01 | 367 |
| IPARP\exl_act.m | 6-Mar-01 | 1,341 |
| IPARP\exl_getmat.m | 1-Nov-99 | 2,681 |
| IPARP\exl_setmat.m | 1-Nov-99 | 4,084 |
| IPARP\fact.m | 12-Jul-99 | 1,296 |
| IPARP\fdr.m | 19-Oct-00 | 2,243 |
| IPARP\fdrc.m | 16-Apr-01 | 845 |
| IPARP\fe_add_dir.m | 2-May-01 | 765 |
| IPARP\fe_pred_act.m | 19-Oct-00 | 3,887 |
| IPARP\fe_pred_anal.m | 19-Oct-00 | 2,558 |
| IPARP\fe_pred_anal2.m | 19-Oct-00 | 4,225 |
| IPARP\fe_pred_dlg.m | 23-Mar-01 | 4,846 |
| IPARP\feat_gen.m | 19-Oct-00 | 3,163 |
| IPARP\featcorr.m | 19-Oct-00 | 4,260 |
| IPARP\featgen.m | 19-Oct-00 | 3,646 |
| IPARP\fec_class.m | 12-Jan-01 | 3,472 |
| IPARP\fext_act.m | 7-May-01 | 2,572 |
| IPARP\fext_dlg.m | 3-May-01 | 3,001 |
| IPARP\ff_ext.m | 22-Dec-00 | 1,878 |
| IPARP\ff_ext2.m | 21-Dec-00 | 2,529 |
| IPARP\filesize.m | 12-Jul-99 | 1,048 |
| IPARP\fill_act.m | 23-Jan-01 | 3,382 |
| IPARP\fill_act_mm.m | 2-Jan-01 | 3,093 |
| IPARP\find_absent.m | 12-Jul-99 | 1,302 |
| IPARP\find_enc.m | 12-Jul-99 | 1,501 |
| IPARP\find_harmonic.m | 30-Apr-01 | 715 |
| IPARP\find_mono_rep.m | 19-Mar-01 | 694 |
| IPARP\find_neighbor.m | 12-Jul-99 | 1,077 |
| IPARP\findkil.m | 8-Dec-00 | 175 |
| IPARP\findm.m | 15-Jul-99 | 1,947 |
| IPARP\findms.m | 15-Jul-99 | 1,629 |
| IPARP\findmu.m | 12-Jul-99 | 1,272 |
| IPARP\findmu2.m | 15-Jul-99 | 1,502 |
| IPARP\findtab.m | 22-Jan-01 | 280 |
| IPARP\firo.m | 12-Jul-99 | 1,688 |
| IPARP\fm_norm.m | 12-Jul-99 | 1,575 |
| IPARP\forward.m | 17-Oct-00 | 1,184 |
| IPARP\freq_tracker.m | 2-May-01 | 768 |
| IPARP\fukunaga.m | 15-Jan-01 | 566 |
| IPARP\fukusep.m | 19-Oct-00 | 1,861 |
| IPARP\fuse_bag.m | 6-Mar-01 | 2,411 |
| IPARP\fuse_boost.m | 6-Mar-01 | 1,852 |
| IPARP\fuse_fec.m | 6-Mar-01 | 3,364 |
| IPARP\fuse_stack.m | 6-Mar-01 | 2,146 |
| IPARP\fusion_dlg.m | 19-Oct-00 | 33,649 |
| IPARP\fusion_dlgg.m | 8-Jan-01 | 2,732 |
| IPARP\ga_fo.m | 19-Dec-00 | 385 |
| IPARP\ga_reduce.m | 27-Feb-01 | 1,536 |
| IPARP\gen_act.m | 20-Dec-00 | 2,817 |
| IPARP\gen_cont_data.m | 31-May-00 | 1,220 |
| IPARP\gen_disc_data.m | 14-Jun-00 | 72 |
| IPARP\gen_hybrid_data.m | 1-Jun-00 | 623 |
| IPARP\gen_hybrid_data2.m | 25-Jul-00 | 690 |
| IPARP\gen_time_series.m | 21-Feb-01 | 35 |
| IPARP\gendemo.m | 23-Jun-94 | 7,442 |
| IPARP\generate_clas_pdf.m | 28-Mar-01 | 1,476 |
| IPARP\generate_cmat.m | 27-Mar-01 | 541 |
| IPARP\genetic.m | 19-Dec-00 | 8,390 |
| IPARP\genplot.m | 23-Jun-94 | 932 |
| IPARP\glm_act.m | 6-Mar-01 | 12,705 |
| IPARP\glm_act_b.m | 6-Mar-01 | 10,711 |
| IPARP\glm_act_hpc.m | 19-Oct-00 | 9,650 |
| IPARP\glm_actg.m | 20-Feb-01 | 3,910 |
| IPARP\glm_dlg.m | 1-Sep-99 | 3,514 |
| IPARP\glm_dlgg.m | 20-Feb-01 | 2,728 |
| IPARP\glm_dlgs.m | 23-Oct-00 | 4,062 |
| IPARP\glmg_body.m | 6-Mar-01 | 8,062 |
| IPARP\glmm.m | 19-Oct-00 | 2,879 |
| IPARP\gmm_act.m | 6-Mar-01 | 13,129 |
| IPARP\gmm_act_b.m | 6-Mar-01 | 10,976 |
| IPARP\gmm_act_hpc.m | 19-Oct-00 | 9,813 |
| IPARP\gmm_actg.m | 20-Feb-01 | 3,998 |
| IPARP\gmm_dlg.m | 1-Sep-99 | 3,862 |
| IPARP\gmm_dlgg.m | 20-Feb-01 | 3,090 |
| IPARP\gmm_dlgs.m | 23-Oct-00 | 4,406 |
| IPARP\gmmg_body.m | 6-Mar-01 | 8,062 |
| IPARP\gmmm.m | 18-May-01 | 3,301 |
| IPARP\group_partition.m | 7-May-01 | 581 |
| IPARP\henon.m | 12-Jul-99 | 1,586 |
| IPARP\hist_unique.m | 8-Dec-00 | 234 |
| IPARP\hist2.m | 2-Apr-01 | 2,190 |
| IPARP\hmm.m | 12-Jul-99 | 3,474 |
| IPARP\hmm_act.m | 19-Oct-00 | 8,659 |
| IPARP\hmm_cl.m | 12-Jul-99 | 1,521 |
| IPARP\hmm_dlg.m | 2-Apr-01 | 2,899 |
| IPARP\hmmk.m | 12-Jul-99 | 3,087 |
| IPARP\hough.m | 10-Jun-99 | 4,173 |
| IPARP\hspc_cmat.m | 19-Oct-00 | 1,734 |
| IPARP\hspc_cmat2.m | 19-Oct-00 | 1,735 |
| IPARP\hspc1 .m | 23-Oct-00 | 3,657 |
| IPARP\Iexplore.m | 13-Oct-00 | 1,726 |
| IPARP\index_sub.m | 13-Jul-99 | 1,499 |
| IPARP\iparp.m | 26-Jul-01 | 16,483 |
| IPARP\isalpha.m | 13-Jul-01 | 336 |
| IPARP\isnum.m | 25-Apr-01 | 110 |
| IPARP\jointPD.m | 16-May-00 | 252 |
| IPARP\jointPDc.m | 31-May-00 | 209 |
| IPARP\k_means_dlg.m | 26-Oct-00 | 2,913 |
| IPARP\km_act.m | 26-Oct-00 | 5,680 |
| IPARP\km_eclass.m | 19-Oct-00 | 1,396 |
| IPARP\km_new_dlg.m | 13-Jul-99 | 1,672 |
| IPARP\knn_act.m | 6-Mar-01 | 13,618 |
| IPARP\knn_act_b.m | 6-Mar-01 | 10,609 |
| IPARP\knn_act_hpc.m | 19-Oct-00 | 9,550 |
| IPARP\knn_actg.m | 19-Oct-00 | 3,960 |
| IPARP\knn_dlg.m | 4-Sep-99 | 3,500 |
| IPARP\knn_dlgg.m | 12-Oct-00 | 2,729 |
| IPARP\knn_dlgs.m | 23-Oct-00 | 4,048 |
| IPARP\knng_body.m | 6-Mar-01 | 9,032 |
| IPARP\knnk.m | 19-Oct-00 | 2,203 |
| IPARP\knnm.m | 22-May-01 | 2,515 |
| IPARP\kread.m | 13-Jul-99 | 1,303 |
| IPARP\kread_excel.m | 20-Dec-00 | 1,021 |
| IPARP\ks_excel.m | 24-Jul-00 | 2,275 |
| IPARP\kwrite.m | 13-Jul-99 | 1,322 |
| IPARP\lfc.m | 6-Mar-01 | 3,091 |
| IPARP\lfc_act.m | 6-Mar-01 | 12,239 |
| IPARP\lfc_act_b.m | 6-Mar-01 | 10,597 |
| IPARP\lfc_act_hpc.m | 19-Oct-00 | 9,538 |
| IPARP\lfc_dlg.m | 2-Sep-99 | 3,289 |
| IPARP\lfc_dlgs.m | 23-Oct-00 | 3,819 |
| IPARP\LLR_integrator.m | 30-May-01 | 730 |
| IPARP\logiregi.m | 10-Jan-01 | 937 |
| IPARP\logit_act.m | 6-Mar-01 | 12,826 |
| IPARP\logit_actg.m | 10-Jan-01 | 3,806 |
| IPARP\logit_dlg.m | 10-Jan-01 | 3,554 |
| IPARP\logit_dlgg.m | 10-Jan-01 | 2,824 |
| IPARP\logitg_body.m | 6-Mar-01 | 8,098 |
| IPARP\minv.m | 13-Jul-99 | 2,034 |
| IPARP\mixturek_of_experts.m | 7-Jun-99 | 1,450 |
| IPARP\mlp_act.m | 6-Mar-01 | 12,715 |
| IPARP\mlp_act_b.m | 6-Mar-01 | 10,606 |
| IPARP\mlp_act_hpc.m | 19-Oct-00 | 9,548 |
| IPARP\mlp_actg.m | 20-Feb-01 | 3,985 |
| IPARP\mlp_dlg.m | 2-Sep-99 | 3,764 |
| IPARP\mlp_dlgg.m | 20-Feb-01 | 2,952 |
| IPARP\mlp_dlgs.m | 23-Oct-00 | 4,318 |
| IPARP\mlp_pr_act.m | 19-Oct-00 | 7,683 |
| IPARP\mlp_pr_dlg.m | 2-Sep-99 | 3,757 |
| IPARP\mlpg_body.m | 6-Mar-01 | 8,062 |
| IPARP\mlpm.m | 28-Mar-01 | 2,919 |
| IPARP\mlprm.m | 31-May-01 | 2,666 |
| IPARP\mlreg.m | 3-Apr-01 | 2,488 |
| IPARP\mlreg_pr_act.m | 3-Apr-01 | 7,786 |
| IPARP\mlreg_pr_dlg.m | 3-Apr-01 | 3,805 |
| IPARP\mlregr.m | 20-Jun-01 | 2,589 |
| IPARP\moe_pr_act.m | 19-Oct-00 | 8,554 |
| IPARP\moe_pr_dlg.m | 13-Jul-99 | 3,541 |
| IPARP\moerm.m | 19-Oct-00 | 2,536 |
| IPARP\mom.m | 19-Oct-00 | 2,071 |
| IPARP\mssk.m | 13-Jul-99 | 1,717 |
| IPARP\mutate.m | 23-Jun-94 | 606 |
| IPARP\mutual_info.m | 2-Apr-01 | 699 |
| IPARP\mvg.m | 16-Jan-01 | 2,921 |
| IPARP\mvg_act.m | 2-May-01 | 12,586 |
| IPARP\mvg_b.m | 6-Mar-01 | 11,503 |
| IPARP\mvg_act_hpc.m | 19-Oct-00 | 10,444 |
| IPARP\mvg_actg.m | 7-May-01 | 3,980 |
| IPARP\mvg_dlg.m | 2-Sep-99 | 3,507 |
| IPARP\mvg_dlgg.m | 7-May-01 | 3,046 |
| IPARP\mvg_dlgs.m | 23-Oct-00 | 4,042 |
| IPARP\mvg_gen.m | 19-Dec-00 | 173 |
| IPARP\mvgg_body.m | 7-May-01 | 8,788 |
| IPARP\mvgg_body_fec.m | 6-Mar-01 | 8,120 |
| IPARP\nbn.m | 25-Jan-01 | 1,792 |
| IPARP\nbn_act.m | 6-Mar-01 | 13,196 |
| IPARP\nbn_actg.m | 20-Feb-01 | 4,233 |
| IPARP\nbn_dlg.m | 15-Jan-01 | 4,084 |
| IPARP\nbn_dlgg.m | 20-Feb-01 | 3,041 |
| IPARP\nfindm.m | 15-Jul-99 | 1,768 |
| IPARP\nl_corr.m | 2-Apr-01 | 1,782 |
| IPARP\nlt_feat.m | 17-Jan-01 | 1,347 |
| IPARP\nlt_toggle.m | 15-Dec-00 | 338 |
| IPARP\nlt_xform.m | 9-Jul-01 | 6,783 |
| IPARP\nnc.m | 13-Jul-99 | 1,816 |
| IPARP\nnc_act.m | 6-Mar-01 | 12,617 |
| IPARP\nnc_act_b.m | 6-Mar-01 | 10,644 |
| IPARP\nnc_act_hpc.m | 19-Oct-00 | 9,585 |
| IPARP\nnc_actg.m | 20-Feb-01 | 3,934 |
| IPARP\nnc_dlg.m | 2-Sep-99 | 3,289 |
| IPARP\nnc_dlgg.m | 20-Feb-01 | 2,503 |
| IPARP\nnc_dlgs.m | 23-Oct-00 | 3,819 |
| IPARP\nncg_body.m | 6-Mar-01 | 8,984 |
| IPARP\normal.m | 11-Apr-01 | 2,288 |
| IPARP\normal_b.m | 7-Sep-99 | 1,251 |
| IPARP\normr2.m | 28-Mar-01 | 172 |
| IPARP\num2pop.m | 26-Feb-01 | 380 |
| IPARP\open_access.m | 25-Apr-01 | 1,782 |
| IPARP\open_data.m | 12-Jun-00 | 262 |
| IPARP\open_excel.m | 19-Oct-00 | 1,685 |
| IPARP\open_excel2.m | 24-Oct-00 | 664 |
| IPARP\open_excel3.m | 25-Oct-00 | 884 |
| IPARP\open_net.m | 12-Jun-00 | 308 |
| IPARP\open_reg.m | 23-Mar-01 | 2,874 |
| IPARP\open_ssdir.m | 1-May-01 | 1,419 |
| IPARP\open_unk.m | 15-Mar-01 | 1,504 |
| IPARP\open1.m | 7-May-01 | 3,715 |
| IPARP\open1c.m | 27-Mar-01 | 3,802 |
| IPARP\open2.m | 25-Oct-00 | 2,138 |
| IPARP\openc.m | 11-Apr-01 | 2,006 |
| IPARP\openr1.m | 25-Aug-99 | 1,462 |
| IPARP\openr2.m | 1-Sep-99 | 1,476 |
| IPARP\opent.m | 19-Oct-00 | 1,543 |
| IPARP\opent_txt.m | 19-Mar-01 | 1,005 |
| IPARP\organize_unk_dat.m | 2-May-01 | 4,804 |
| IPARP\ortho.m | 6-Mar-01 | 3,620 |
| IPARP\ortho_3d.m | 19-Oct-00 | 2,233 |
| IPARP\orthotemp.m | 30-Jul-00 | 992 |
| IPARP\outlier_removal.m | 2-Apr-01 | 561 |
| IPARP\output_tree.m | 2-Feb-01 | 1,585 |
| IPARP\part_boot.m | 19-Oct-00 | 767 |
| IPARP\part_random.m | 20-Oct-00 | 1,139 |
| IPARP\part_stratify.m | 20-Oct-00 | 706 |
| IPARP\partfb.m | 30-May-01 | 3,263 |
| IPARP\partfbr.m | 19-Oct-00 | 2,226 |
| IPARP\partition.m | 12-Feb-01 | 947 |
| IPARP\partran.m | 19-Oct-00 | 2,562 |
| IPARP\partranr.m | 19-Oct-00 | 2,498 |
| IPARP\partt_random.m | 7-May-01 | 1,271 |
| IPARP\peak_interp.m | 25-Apr-01 | 281 |
| IPARP\plot_candle.m | 15-Dec-00 | 708 |
| IPARP\plot_indi.m | 8-Jan-01 | 1,210 |
| IPARP\plot_MD.m | 1-Dec-00 | 217 |
| IPARP\plot_pdf.m | 8-Jan-01 | 2,398 |
| IPARP\plot_time.m | 19-Oct-00 | 520 |
| IPARP\plot41d.m | 16-Apr-01 | 2,122 |
| IPARP\pnn.m | 14-Jul-99 | 1,827 |
| IPARP\pnn_act.m | 6-Mar-01 | 12,603 |
| IPARP\pnn_act_b.m | 6-Mar-01 | 10,516 |
| IPARP\pnn_act_hpc.m | 19-Oct-00 | 9,457 |
| IPARP\pnn_actg.m | 19-Oct-00 | 3,756 |
| IPARP\pnn_dlg.m | 2-Sep-99 | 3,515 |
| IPARP\pnn_dlgg.m | 12-Oct-00 | 2,728 |
| IPARP\pnn_dlgs.m | 23-Oct-00 | 4,061 |
| IPARP\pnng_body.m | 6-Mar-01 | 8,053 |
| IPARP\pnng_body_fec.m | 6-Mar-01 | 8,077 |
| IPARP\podr_anal.m | 2-Mar-01 | 2,948 |
| IPARP\Poisson.m | 28-Mar-95 | 1,228 |
| IPARP\pop2str.m | 26-Feb-01 | 203 |
| IPARP\pred_dlg.m | 14-Jul-99 | 4,683 |
| IPARP\prep_discretize.m | 11-Jan-01 | 1,377 |
| IPARP\prep_outlier.m | 11-Jan-01 | 532 |
| IPARP\prep_represent.m | 23-Jan-01 | 2,574 |
| IPARP\prepare_affy_data.m | 23-Feb-01 | 741 |
| IPARP\prepare_data.m | 27-Mar-01 | 5,164 |
| IPARP\Prob.m | 14-Jul-99 | 1,674 |
| IPARP\process_fn.m | 16-Jan-01 | 147 |
| IPARP\profit_calc.m | 2-Jan-01 | 1,694 |
| IPARP\prune.m | 2-Feb-01 | 2,782 |
| IPARP\prune_C45.m | 2-Feb-01 | 2,820 |
| IPARP\prune_det_coeff.m | 2-Feb-01 | 544 |
| IPARP\prune_det_coeff_C45.m | 2-Feb-01 | 553 |
| IPARP\prune_errs.m | 2-Feb-01 | 838 |
| IPARP\prune_errs_C45.m | 2-Feb-01 | 852 |
| IPARP\prune_kill_kids.m | 2-Feb-01 | 1,789 |
| IPARP\prune_points.m | 2-Feb-01 | 1,950 |
| IPARP\prune_tree.m | 2-Feb-01 | 925 |
| IPARP\prune_tree_C45.m | 2-Feb-01 | 1,023 |
| IPARP\prune_tree_points.m | 2-Feb-01 | 822 |
| IPARP\rand_order.m | 14-Jul-99 | 1,797 |
| IPARP\randint.m | 2-Feb-01 | 265 |
| IPARP\rank_coh.m | 2-Apr-01 | 350 |
| IPARP\rank_corr.m | 13-Feb-01 | 571 |
| IPARP\rank1.m | 16-Apr-01 | 3,963 |
| IPARP\rank1_b.m | 19-Oct-00 | 1,631 |
| IPARP\rank1_sr.m | 13-Jul-01 | 4,162 |
| IPARP\rankc.m | 19-Oct-00 | 2,545 |
| IPARP\rankc_b.m | 19-Oct-00 | 2,108 |
| IPARP\ranord.m | 14-Jul-99 | 1,571 |
| IPARP\raylei.m | 19-Oct-00 | 2,295 |
| IPARP\rayleigh.m | 6-Mar-01 | 2,912 |
| IPARP\rayleigh_3d.m | 19-Oct-00 | 2,173 |
| IPARP\raytemp.m | 6-Mar-01 | 2,888 |
| IPARP\rbf_act.m | 6-Mar-01 | 12,729 |
| IPARP\rbf_act_b.m | 6-Mar-01 | 10,672 |
| IPARP\rbf_act_hpc.m | 19-Oct-00 | 9,614 |
| IPARP\rbf_actg.m | 20-Feb-01 | 3,985 |
| IPARP\rbf_dlg.m | 2-Sep-99 | 3,963 |
| IPARP\rbf_dlgg.m | 20-Feb-01 | 2,949 |
| IPARP\rbf_dlgs.m | 23-Oct-00 | 4,518 |
| IPARP\rbf_pr_act.m | 19-Oct-00 | 7,698 |
| IPARP\rbf_pr_dlg.m | 2-Sep-99 | 3,759 |
| IPARP\rbfg_body.m | 6-Mar-01 | 8,062 |
| IPARP\rbfm.m | 15-Jan-01 | 3,250 |
| IPARP\rbfrm.m | 31-May-01 | 2,817 |
| IPARP\read_affy.m | 21-Feb-01 | 1,350 |
| IPARP\read_ascii.m | 24-May-01 | 956 |
| IPARP\read_txt.m | 16-Jan-01 | 1,471 |
| IPARP\read_txt2.m | 22-Jan-01 | 1,733 |
| IPARP\recompr.m | 14-Jul-99 | 1,440 |
| IPARP\Regr.m | 5-Dec-98 | 949 |
| IPARP\regression_datgen.m | 14-Jul-99 | 235 |
| IPARP\removems.m | 14-Jul-99 | 1,403 |
| IPARP\reproduc.m | 23-Jun-94 | 758 |
| IPARP\rest_skm.m | 14-Jul-99 | 1,873 |
| IPARP\rocho.m | 2-Mar-01 | 2,323 |
| IPARP\rtree.m | 22-Mar-01 | 5,848 |
| IPARP\rugplot.m | 12-Dec-00 | 803 |
| IPARP\run_access.m | 15-Mar-01 | 720 |
| IPARP\run_fusion.m | 12-Jan-01 | 10,752 |
| IPARP\run_hspc1.m | 23-Oct-00 | 1,929 |
| IPARP\Runmed.m | 8-Oct-93 | 371 |
| IPARP\save_net.m | 13-Jun-00 | 174 |
| IPARP\savefea.m | 25-Aug-99 | 1,248 |
| IPARP\setValuesFromResiduals.m | 5-Mar-01 | 630 |
| IPARP\show_cont.m | 12-Jan-01 | 1,954 |
| IPARP\show_dis.m | 25-Apr-01 | 3,013 |
| IPARP\show_time_series.m | 20-Mar-01 | 873 |
| IPARP\showall.m | 19-Oct-00 | 1,519 |
| IPARP\showall_time.m | 19-Oct-00 | 1,589 |
| IPARP\showcont.m | 23-Jan-01 | 2,994 |
| IPARP\showdis.m | 2-Apr-01 | 1,646 |
| IPARP\shuffle.m | 2-Feb-01 | 325 |
| IPARP\sigmoid.m | 14-Dec-00 | 138 |
| IPARP\simpleRTree.m | 5-Mar-01 | 4,088 |
| IPARP\skm.m | 14-Jul-99 | 2,892 |
| IPARP\slide1 .m | 6-Dec-00 | 702 |
| IPARP\sort_fm.m | 19-Oct-00 | 768 |
| IPARP\sort_fm_clas.m | 2-Mar-01 | 242 |
| IPARP\sp_master.m | 25-Apr-01 | 5,036 |
| IPARP\speaker_var.m | 3-May-01 | 986 |
| IPARP\spiht_act.m | 1-Sep-99 | 3,209 |
| IPARP\spiht_eval.m | 1-Sep-99 | 2,886 |
| IPARP\SS_anal.m | 11-Apr-01 | 2,150 |
| IPARP\SS_plot.m | 12-Apr-01 | 811 |
| IPARP\SSS_anal.m | 10-Nov-00 | 2,099 |
| IPARP\SSS_plot.m | 19-Oct-00 | 635 |
| IPARP\SSufficientMain.m | 1-Mar-01 | 290 |
| IPARP\SSufficientStat.m | 6-Mar-01 | 2,667 |
| IPARP\str2num_mult.m | 26-Jul-01 | 212 |
| IPARP\str2pop.m | 16-Jun-01 | 403 |
| IPARP\strh2strv.m | 15-Mar-01 | 184 |
| IPARP\strinsert.m | 17-Jan-01 | 496 |
| IPARP\SufficientMain.m | 11-Apr-01 | 281 |
| IPARP\SufficientStat.m | 12-Apr-01 | 2,779 |
| IPARP\svd_te.m | 1-Jun-01 | 3,491 |
| IPARP\svd_te_fill.m | 2-Jan-01 | 2,006 |
| IPARP\svd_te_help.m | 14-Jul-99 | 1,190 |
| IPARP\svdte_pr_act.m | 19-Oct-00 | 7,747 |
| IPARP\svdte_pr_dlg.m | 2-Sep-99 | 4,003 |
| IPARP\svm.m | 13-Jul-01 | 3,140 |
| IPARP\svm_act.m | 6-Mar-01 | 13,591 |
| IPARP\svm_dlg.m | 13-Jul-01 | 3,560 |
| IPARP\svmkernel2.m | 15-Sep-00 | 1,099 |
| IPARP\sysparam.m | 7-May-01 | 349 |
| IPARP\Tally.m | 2-May-97 | 333 |
| IPARP\test_access2fm.m | 25-Apr-01 | 192 |
| IPARP\test_brn.m | 28-Mar-01 | 262 |
| IPARP\test_freq_tracker.m | 2-May-01 | 147 |
| IPARP\test_hmeq.m | 22-Jan-01 | 158 |
| IPARP\test_logit.m | 10-Jan-01 | 160 |
| IPARP\test_mart.m | 27-Mar-01 | 366 |
| IPARP\test_msmt.m | 9-Feb-01 | 534 |
| IPARP\test_roc.m | 17-Oct-00 | 155 |
| IPARP\test_stress.m | 1-May-01 | 3,998 |
| IPARP\testgen.m | 23-Jun-94 | 139 |
| IPARP\threearb.m | 1-Sep-99 | 2,420 |
| IPARP\trivial_know.m | 23-Apr-01 | 312 |
| IPARP\trn.m | 19-Dec-00 | 13,000 |
| IPARP\TS_fe.m | 23-Mar-01 | 1,587 |
| IPARP\TS_feat_ext.m | 23-Mar-01 | 1,302 |
| IPARP\TS_norm_plot.m | 20-Mar-01 | 602 |
| IPARP\TS_xform.m | 27-Mar-01 | 2,648 |
| IPARP\tst.m | 19-Dec-00 | 4,397 |
| IPARP\twoDmom.m | 19-Oct-00 | 2,216 |
| IPARP\uniquek.m | 14-Jul-99 | 1,258 |
| IPARP\USASI.M | 11-Dec-00 | 1,671 |
| IPARP\view3d.m | 28-Jun-99 | 13,442 |
| IPARP\vq.m | 9-Jul-98 | 1,043 |
| IPARP\vqi.c.m | 26-Oct-00 | 12,199 |
| IPARP\waterfall_k.m | 20-Apr-01 | 331 |
| IPARP\wav_fe.m | 25-Apr-01 | 3,134 |
| IPARP\xover.m | 23-Jun-94 | 703 |
| IPARP\ZEROTRIM.M | 12-May-98 | 1,259 |
| IPARP\MART\addResiduals.c | 26-Jul-01 | 21,359 |
| IPARP\MART\addResiduals_mex.c | 26-Jul-01 | 1,233 |
| IPARP\MART\addResidualsC.c | 19-Feb-01 | 3,755 |
| IPARP\MART\martEval.c | 26-Jul-01 | 8,231 |
| IPARP\MART\martEval_mex.c | 26-Jul-01 | 5,693 |
| IPARP\MART\martEvalC.c | 21-Feb-01 | 5,010 |
| IPARP\MART\nominalSplitC.c | 20-Feb-01 | 3,842 |
| IPARP\MART\nominalSplitC_mex.c | 26-Jul-01 | 1,378 |
| IPARP\MART\ | 26-Jul-01 | 5,361 |
| nominalSplitC_mex_interface.c | | |
| IPARP\MART\numericSplitC.c | 20-Feb-01 | 2,597 |
| IPARP\MART\setValuesFromResiduals.c | 26-Jul-01 | 12,710 |
| IPARP\MART\ | 26-Jul-01 | 3,947 |
| setValuesFromResiduals_mex.c | | |
| IPARP\MART\setValuesFromResidualsC.c | 19-Feb-01 | 3,772 |
| IPARP\MART\addResiduals.h | 26-Jul-01 | 1,142 |
| IPARP\MART\martEval.h | 26-Jul-01 | 966 |
| IPARP\MART\martEvalC_mex_interface.h | 26-Jul-01 | 1,175 |
| IPARP\MART\median.h | 26-Jul-01 | 874 |
| IPARP\MART\ | 26-Jul-01 | 1,300 |
| nominalSplitC_mex_interface.h | | |
| IPARP\MART\setValuesFromResiduals.h | 26-Jul-01 | 1,224 |
| IPARP\MART\addResiduals.m | 16-Feb-01 | 1,070 |
| IPARP\MART\averageNodeOutput.m | 21-Feb-01 | 272 |
| IPARP\MART\cartPredict.m | 21-Feb-01 | 1,154 |
| IPARP\MART\kread.m | 13-Jul-99 | 1,303 |
| IPARP\MART\mart.m | 22-Mar-01 | 2,305 |
| IPARP\MART\mart2.m | 21-May-01 | 2,260 |
| IPARP\MART\martAccuracy.m | 5-Mar-01 | 656 |
| IPARP\MART\martEval.m | 5-Mar-01 | 811 |
| IPARP\MART\martPredict.m | 5-Mar-01 | 624 |
| IPARP\MART\martr.m | 3-Apr-01 | 2,299 |
| IPARP\MART\martTrain.m | 26-Jul-01 | 6,368 |
| IPARP\MART\partition.m | 12-Feb-01 | 947 |
| IPARP\MART\rtree.m | 22-Mar-01 | 5,848 |
| IPARP\MART\setValuesFromResiduals.m | 5-Mar-01 | 630 |
| IPARP\MART\simpleRTree.m | 5-Mar-01 | 4,088 |
| IPARP\MART\test_mart.m | 27-Mar-01 | 366 |
| IPARP\MART\README.txt | 22-Mar-01 | 4,354 |
| IPT\ChangeLog | 2-Jun-00 | 1,467 |
| IPT\group | 2-May-00 | 80 |
| IPT\Makefile | 1-Jun-00 | 1,151 |
| IPT\makefile,v | 27-Mar-00 | 2,444 |
| IPT\passwd | 2-May-00 | 52 |
| IPT\perms | 2-May-00 | 579 |
| IPT\README | 8-Jun-00 | 2,934 |
| IPT\README,v | 20-Mar-00 | 6,266 |
| IPT\access.log.000 | 10-Jul-01 | 148,212 |
| IPT\access.log.001 | 9-Jul-01 | 72,473 |
| IPT\nsmysql.001 | 27-Mar-00 | 3,858 |
| IPT\access.log.002 | 8-Jul-01 | 0 |
| IPT\access.log.003 | 7-Jul-01 | 5,239 |
| IPT\access.log.004 | 6-Jul-01 | 185,756 |
| IPT\hosts.allow | 2-May-00 | 324 |
| IPT\_ISDEL.EXE | 19-Nov-97 | 8,192 |
| IPT\convert_image.exe | 6-Sep-00 | 4,370,516 |
| IPT\iptalg.exe | 11-Jul-01 | 311,363 |
| IPT\nsd.exe | 6-Sep-00 | 16,384 |
| IPT\SETUP.EXE | 19-Nov-97 | 59,904 |
| IPT\string_escape.exe | 22-Aug-00 | 163,912 |
| IPT\unzip .exe | 26-Aug-98 | 141,824 |
| IPT\zip.exe | 16-May-98 | 117,248 |
| IPT\_SETUP.DLL | 19-Nov-97 | 11,264 |
| IPT\getHTTP.dll | 19-Sep-00 | 36,864 |
| IPT\libmySQL.dll | 4-Jul-00 | 393,274 |
| IPT\nscgi.dll | 6-Sep-00 | 24,576 |
| IPT\nscp.dll | 6-Sep-00 | 20,480 |
| IPT\nsd.dll | 6-Sep-00 | 245,760 |
| IPT\nslog.dll | 6-Sep-00 | 20,480 |
| IPT\nsmysql.dll | 21-Aug-00 | 213,066 |
| IPT\nsperm.dll | 6-Sep-00 | 28,672 |
| IPT\nssock.dll | 6-Sep-00 | 20,480 |
| IPT\nsssle.dll | 6-Sep-00 | 90,112 |
| IPT\nstcl.dll | 6-Sep-00 | 487,424 |
| IPI\nsthread.dll | 6-Sep-00 | 32,768 |
| IPT\LAYOUT.BIN | 4-Jul-00 | 353 |
| IPT\logo.bmp | 3-Sep-00 | 268,678 |
| IPT\logo_small.bmp | 3-Sep-00 | 12,562 |
| IPT\plain logo.bmp | 28-Aug-00 | 3,693,882 |
| IPT\SETUP.BMP | 12-Feb-98 | 86,878 |
| IPT\cfar.c | 22-Sep-00 | 6,136 |
| IPT\convert_image.c | 23-Sep-00 | 6,454 |
| IPT\detect.c | 10-Jul-01 | 16,282 |
| IPT\dispatcher.c | 11-Jul-01 | 28,155 |
| IPT\feature.c | 22-Sep-00 | 22,719 |
| IPT\filter.c | 10-Jul-01 | 9,763 |
| IPT\gray.c | 22-Sep-00 | 3,649 |
| IPT\grayco.c | 9-Jul-01 | 4,255 |
| IPT\histeq.c | 22-Sep-00 | 1,821 |
| IPT\ipseg.c | 22-Sep-00 | 5,063 |
| IPT\iptutils.c | 10-Jul-01 | 18,081 |
| IPT\matlab_classify.c | 6-Jul-01 | 12,263 |
| IPT\matlab_im_fn.c | 10-Jul-01 | 2,529 |
| IPT\mysql.c | 21-Aug-00 | 20,056 |
| IPT\ps.c | 11-Jul-01 | 3,920 |
| IPT\region_merge.c | 11-Jul-01 | 19,176 |
| IPT\region_point.c | 23-Sep-00 | 12,782 |
| IPT\shape.c | 10-Jul-01 | 15,463 |
| IPT\string_escape.c | 23-Sep-00 | 1,678 |
| IPT\mysql.c,v | 2-Jun-00 | 26,288 |
| IPT\_SYS1.CAB | 4-Jul-00 | 186,302 |
| IPT\_USER1.CAB | 4-Jul-00 | 45,130 |
| IPT\DATA1.CAB | 4-Jul-00 | 8,193,885 |
| IPT\blen1110.css | 4-Sep-00 | 10,816 |
| IPT\indu1010.css | 28-Aug-00 | 10,348 |
| IPT\master04_stylesheet.css | 21-Sep-00 | 7,672 |
| IPT\SETUP.INI | 4-Jul-00 | 62 |
| IPT\LANG.DAT | 30-May-97 | 4,557 |
| IPT\OS.DAT | 6-May-97 | 417 |
| IPT\hosts.deny | 2-May-00 | 326 |
| IPT\iptalg.dep | 28-Jun-01 | 82 |
| IPT\nsmysql.dep | 21-Aug-00 | 83 |
| IPT\string_escape.dep | 22-Aug-00 | 89 |
| IPT\UTIL_rwfile_st_exe.dep | 10-Aug-00 | 818 |
| IPT\canny.desc | 10-Jul-01 | 186 |
| IPT\gauss_noise.desc | 10-Jul-01 | 127 |
| IPT\multiplicative_noise.desc | 10-Jul-01 | 122 |
| IPT\wiener.desc | 10-Jul-01 | 142 |
| IPT\iptalg.dsp | 9-Jul-01 | 6,201 |
| IPT\nsmysql.dsp | 22-Aug-00 | 4,572 |
| IPT\string_escape.dsp | 22-Aug-00 | 5,490 |
| IPT\UTIL_rwfile_st_exe.dsp | 10-Aug-00 | 7,601 |
| IPT\iptalg.dsw | 28-Jun-01 | 535 |
| IPT\nsmysql.dsw | 21-Aug-00 | 537 |
| IPT\string_escape.dsw | 22-Aug-00 | 549 |
| IPT\UTIL_rwfile_st_exe.dsw | 4-Aug-00 | 552 |
| IPT\_INST32I.EX_{—} | 19-Nov-97 | 300,178 |
| IPT\nsmysql.exp | 21-Aug-00 | 823 |
| IPT\andrewphoto.gif | 6-Sep-00 | 7,287 |
| IPT\architecture.gif | 4-Sep-00 | 32,392 |
| IPT\blebul1a.gif | 4-Sep-00 | 663 |
| IPT\blebul2a.gif | 4-Sep-00 | 308 |
| IPT\blebul3a.gif | 4-Sep-00 | 311 |
| IPT\blesepa.gif | 4-Sep-00 | 292 |
| IPT\buttons.gif | 21-Sep-00 | 1,834 |
| IPT\concept_web.gif | 4-Sep-00 | 17,039 |
| IPT\indbul1a.gif | 28-Aug-00 | 501 |
| IPT\indbul2a.gif | 28-Aug-00 | 419 |
| IPT\indbul3a.gif | 28-Aug-00 | 420 |
| IPT\indhorsa.gif | 28-Aug-00 | 381 |
| IPT\logo.gif | 3-Sep-00 | 19,370 |
| IPT\logo_small.gif | 3-Sep-00 | 1,916 |
| IPT\master04_image002.gif | 21-Sep-00 | 1,588 |
| IPT\master04_image003.gif | 21-Sep-00 | 1,301 |
| IPT\slide0001_image025.gif | 21-Sep-00 | 699 |
| IPT\slide0001_image027.gif | 21-Sep-00 | 450 |
| IPT\slide0001_image028.gif | 21-Sep-00 | 927 |
| IPT\slide0001_image030.gif | 21-Sep-00 | 4,595 |
| IPT\slide0001_image031.gif | 21-Sep-00 | 6,018 |
| IPT\slide0001_image033.gif | 21-Sep-00 | 3,175 |
| IPT\slide0001_image034.gif | 21-Sep-00 | 21,779 |
| IPT\slide0002_image045.gif | 21-Sep-00 | 989 |
| IPT\slide0002_image046.gif | 21-Sep-00 | 550 |
| IPT\slide0002_image047.gif | 21-Sep-00 | 583 |
| IPT\slide0002_image048.gif | 21-Sep-00 | 635 |
| IPT\slide0002_image049.gif | 21-Sep-00 | 511 |
| IPT\slide0002_image050.gif | 21-Sep-00 | 900 |
| IPT\slide0002_image052.gif | 21-Sep-00 | 643 |
| IPT\slide0002_image053.gif | 21-Sep-00 | 628 |
| IPT\slide0002_image054.gif | 21-Sep-00 | 229 |
| IPT\slide0002_image055.gif | 21-Sep-00 | 273 |
| IPT\slide0002_image056.gif | 21-Sep-00 | 327 |
| IPT\slide0002_image057.gif | 21-Sep-00 | 1,224 |
| IPT\slide0002_image058.gif | 21-Sep-00 | 2,106 |
| IPT\slide0002_image059.gif | 21-Sep-00 | 2,104 |
| IPT\slide0003_image035.gif | 21-Sep-00 | 9,190 |
| IPT\slide0003_image036.gif | 21-Sep-00 | 4,865 |
| IPT\slide0003_image037.gif | 21-Sep-00 | 3,787 |
| IPT\slide0003_image038.gif | 21-Sep-00 | 3,689 |
| IPT\slide0003_image039.gif | 21-Sep-00 | 8,794 |
| IPT\slide0004_image040.gif | 21-Sep-00 | 10,795 |
| IPT\slide0004_image041.gif | 21-Sep-00 | 16,170 |
| IPT\slide0004_image042.gif | 21-Sep-00 | 3,283 |
| IPT\slide0004_image043.gif | 21-Sep-00 | 9,068 |
| IPT\slide0009_image074.gif | 21-Sep-00 | 1,295 |
| IPT\slide0009_image075.gif | 21-Sep-00 | 890 |
| IPT\slide0009_image076.gif | 21-Sep-00 | 385 |
| IPT\slide0009_image077.gif | 21-Sep-00 | 924 |
| IPT\slide0009_image078.gif | 21-Sep-00 | 36,898 |
| IPT\slide0012_image066.gif | 21-Sep-00 | 591 |
| IPT\slide0012_image067.gif | 21-Sep-00 | 635 |
| IPT\slide0012_image069.gif | 21-Sep-00 | 13,904 |
| IPT\slide0012_image070.gif | 21-Sep-00 | 11,310 |
| IPT\slide0012_image071.gif | 21-Sep-00 | 852 |
| IPT\slide0012_image072.gif | 21-Sep-00 | 1,623 |
| IPT\slide0012_image073.gif | 21-Sep-00 | 898 |
| IPT\slide0013_image060.gif | 21-Sep-00 | 548 |
| IPT\slide0013_image061.gif | 21-Sep-00 | 1,483 |
| IPT\slide0013_image062.gif | 21-Sep-00 | 201 |
| IPT\slide0013_image063.gif | 21-Sep-00 | 11,488 |
| IPT\slide0013_image064.gif | 21-Sep-00 | 987 |
| IPT\slide0013_image065.gif | 21-Sep-00 | 1,946 |
| IPT\slide0014_image004.gif | 21-Sep-00 | 991 |
| IPT\slide0014_image005.gif | 21-Sep-00 | 1,199 |
| IPT\slide0014_image006.gif | 21-Sep-00 | 1,335 |
| IPT\slide0014_image007.gif | 21-Sep-00 | 1,024 |
| IPT\slide0014_image014.gif | 21-Sep-00 | 1,612 |
| IPT\slide0014_image015.gif | 21-Sep-00 | 1,218 |
| IPT\slide0014_image016.gif | 21-Sep-00 | 1,024 |
| IPT\slide0014_image022.gif | 21-Sep-00 | 2,110 |
| IPT\slide0014_image023.gif | 21-Sep-00 | 925 |
| IPT\Makefile.global | 17-Aug-00 | 8,486 |
| IPT\man.groundtruth | 9-Jul-01 | 156 |
| IPT\ipt.h | 10-Jul-01 | 19,131 |
| IPT\ns.h | 17-Aug-00 | 43,099 |
| IPT\nsextmsg.h | 2-Aug-00 | 2,537 |
| IPT\nspd.h | 2-Aug-00 | 4,498 |
| IPT\nsthread.h | 8-Aug-00 | 13,516 |
| IPT\tcl.h | 8-Aug-00 | 2,131 |
| IPT\tcl76.h | 2-May-00 | 44,044 |
| IPT\tcl83.h | 14-Aug-00 | 59,506 |
| IPT\tclDecls.h | 14-Aug-00 | 133,199 |
| IPT\batch.html | 22-Jun-01 | 702 |
| IPT\batch_classifiers.html | 22-Sep-00 | 608 |
| IPT\batch_detection.html | 11-Jul-01 | 1,052 |
| IPT\batch_header.html | 21-Jun-01 | 297 |
| IPT\data.html | 6-Sep-00 | 471 |
| IPT\data_header.html | 21-Jun-01 | 185 |
| IPT\error.htm | 21-Sep-00 | 671 |
| IPT\explore.html | 20-Jun-01 | 548 |
| IPT\explore_header.html | 21-Jun-01 | 188 |
| IPT\frame.htm | 21-Sep-00 | 1,169 |
| IPT\fullscreen.htm | 21-Sep-00 | 493 |
| IPT\index.html | 28-Aug-00 | 421 |
| IPT\IPT.htm | 21-Sep-00 | 2,508 |
| IPT\ipt_admin.html | 23-Sep-00 | 174 |
| IPT\ipt_ipt_doc.html | 11-Jul-01 | 10,306 |
| IPT\ipt_logon.html | 5-Jul-01 | 340 |
| IPT\ipt_new_user.html | 28-Aug-00 | 534 |
| IPT\ipt_upload.html | 22-Jun-01 | 1,048 |
| IPT\ipt_upload_alg.html | 10-Jul-01 | 804 |
| IPT\master01.htm | 21-Sep-00 | 5,373 |
| IPT\master04.htm | 21-Sep-00 | 1,873 |
| IPT\master05.htm | 21-Sep-00 | 1,812 |
| IPT\outline.htm | 21-Sep-00 | 14,833 |
| IPT\slide0001.htm | 21-Sep-00 | 18,839 |
| IPT\slide0002.htm | 21-Sep-00 | 12,365 |
| IPT\slide0003.htm | 21-Sep-00 | 12,780 |
| IPT\slide0004.htm | 21-Sep-00 | 15,111 |
| IPT\slide0007.htm | 21-Sep-00 | 7,547 |
| IPT\slide0008.htm | 21-Sep-00 | 5,984 |
| IPT\slide0009.htm | 21-Sep-00 | 29,653 |
| IPT\slide0010.htm | 21-Sep-00 | 6,934 |
| IPT\slide0012.htm | 21-Sep-00 | 27,289 |
| IPT\slide0013.htm | 21-Sep-00 | 33,921 |
| IPT\slide0014.htm | 21-Sep-00 | 13,452 |
| IPT\what_the_freak.html | 10-Jul-01 | 94 |
| IPT\vc60.idb | 22-Aug-00 | 33,792 |
| IPT\iptalg.ilk | 11-Jul-01 | 349,812 |
| IPT\nsmysql.ilk | 21-Aug-00 | 316,432 |
| IPT\string_escape.ilk | 22-Aug-00 | 177,864 |
| IPT\SETUP.INS | 30-Jan-00 | 57,397 |
| IPT\explore_layout.jpg | 4-Sep-00 | 129,263 |
| IPT\man1.jpg | 3-Jul-01 | 2,513 |
| IPT\man2.jpg | 3-Jul-01 | 3,606 |
| IPT\man3.jpg | 3-Jul-01 | 2,099 |
| IPT\slide0002_image051.jpg | 21-Sep-00 | 641 |
| IPT\slide0012_image068.jpg | 21-Sep-00 | 641 |
| IPT\slide0014_image017.jpg | 21-Sep-00 | 144,595 |
| IPT\slide0014_image019.jpg | 21-Sep-00 | 164,711 |
| IPT\slide0014_image021.jpg | 21-Sep-00 | 262,594 |
| IPT\iptutil.js | 22-Jun-01 | 12,425 |
| IPT\script.js | 21-Sep-00 | 16,880 |
| IPT\nsd.lib | 6-Sep-00 | 82,236 |
| IPT\nsmysql.lib | 21-Aug-00 | 2,292 |
| IPT\nstcl.lib | 6-Sep-00 | 157,008 |
| IPT\nsthread.lib | 6-Sep-00 | 30,682 |
| IPT\SETUP.LID | 4-Jul-00 | 49 |
| IPT\access.log | 11-Jul-01 | 89,673 |
| IPT\server.log | 6-Sep-00 | 0 |
| IPT\alg_file.m | 21-Jun-01 | 56 |
| IPT\canny.m | 10-Jul-01 | 144 |
| IPT\gauss_noise.m | 10-Jul-01 | 206 |
| IPT\multiplicative_noise.m | 10-Jul-01 | 212 |
| IPT\real_alg.m | 22-Jun-01 | 206 |
| IPT\wiener.m | 10-Jul-01 | 143 |
| IPT\iptalg.mak | 9-Jul-01 | 9,016 |
| IPT\nsmysql.mak | 22-Aug-00 | 4,488 |
| IPT\string_escape.mak | 22-Aug-00 | 4,514 |
| IPT\UTIL_rwfile_st_exe.mak | 10-Aug-00 | 8,738 |
| IPT\delegates.mgk | 25-Jun-00 | 5,575 |
| IPT\magic.mgk | 25-Jun-00 | 1,808 |
| IPT\batch_choose_images.adp | 5-Jul-01 | 2,032 |
| IPT\batch_fm.adp | 21-Sep-00 | 439 |
| IPT\batch_funcs.adp | 9-Jul-01 | 3,051 |
| IPT\data_report.adp | 6-Jul-01 | 2,081 |
| IPT\data_report_select.adp | 13-Sep-00 | 762 |
| IPT\explore_funcs.adp | 5-Jul-01 | 2,121 |
| IPT\explore_image_pane.adp | 5-Jul-01 | 3,221 |
| IPT\ipt_choices.adp | 21-Jun-01 | 1,170 |
| IPT\IPT.ppt | 12-Jul-01 | 6,008,832 |
| IPT\architecture.doc | 12-Jul-01 | 330,240 |
| IPT\Makefile.module | 2-May-00 | 667 |
| IPT\start-nsd.bat | 2-Aug-00 | 62 |
| IPT\iptalg.ncb | 11-Jul-01 | 140,288 |
| IPT\nsmysql.ncb | 22-Aug-00 | 41,984 |
| IPT\string_escape.ncb | 23-Sep-00 | 82,944 |
| IPT\UTIL_rwfile_st_exe.ncb | 23-Sep-00 | 50,176 |
| IPT\cfar.obj | 10-Jul-01 | 9,826 |
| IPT\detect.obj | 10-Jul-01 | 21,737 |
| IPT\dispatcher.obj | 11-Jul-01 | 28,098 |
| IPT\feature.obj | 10-Jul-01 | 25,546 |
| IPT\filter.obj | 10-Jul-01 | 14,180 |
| IPT\gray.obj | 10-Jul-01 | 10,757 |
| IPT\grayco.obj | 10-Jul-01 | 10,633 |
| IPT\histeq.obj | 10-Jul-01 | 5,524 |
| IPT\ipseg.obj | 10-Jul-01 | 9,629 |
| IPT\iptutils.obj | 10-Jul-01 | 34,753 |
| IPT\matched.obj | 10-Jul-01 | 2,722 |
| IPT\matlab_classify.obj | 6-Jul-01 | 17,684 |
| IPT\matlab_im_fn.obj | 10-Jul-01 | 7,600 |
| IPT\mysql.obj | 21-Aug-00 | 42,883 |
| IPT\process.obj | 3-Jul-01 | 1,298 |
| IPT\ps.obj | 11-Jul-01 | 9,431 |
| IPT\region_merge.obj | 11-Jul-01 | 20,486 |
| IPT\region_point.obj | 10-Jul-01 | 13,856 |
| IPT\shape.obj | 11-Jul-01 | 34,393 |
| IPT\string_escape.obj | 22-Aug-00 | 4,093 |
| IPT\convert_image.opt | 19-Sep-00 | 43,520 |
| IPT\iptalg.opt | 11-Jul-01 | 58,880 |
| IPT\nsmysql.opt | 22-Aug-00 | 53,760 |
| IPT\string_escape.opt | 23-Sep-00 | 53,760 |
| IPT\UTIL_rwfile_st_exe.opt | 23-Sep-00 | 54,784 |
| IPT\iptalg.pch | 11-Jul-01 | 519,960 |
| IPT\nsmysql.pch | 21-Aug-00 | 157,260 |
| IPT\string_escape.pch | 22-Aug-00 | 225,072 |
| IPT\iptalg.pdb | 11-Jul-01 | 795,648 |
| IPT\nsmysql.pdb | 21-Aug-00 | 582,656 |
| IPT\string_escape.pdb | 22-Aug-00 | 427,008 |
| IPT\vc60.pdb | 22-Aug-00 | 53,248 |
| IPT\certfile.pem | 5-Sep-00 | 1,066 |
| IPT\keyfile.pem | 5-Sep-00 | 709 |
| IPT\iptalg.plg | 11-Jul-01 | 2,980 |
| IPT\nsmysql.plg | 21-Aug-00 | 248 |
| IPT\string_escape.plg | 22-Aug-00 | 260 |
| IPT\UTIL_rwfile_st_exe.plg | 6-Sep-00 | 3,620 |
| IPT\master04_image001.png | 21-Sep-00 | 1,734 |
| IPT\slide0001_image024.png | 21-Sep-00 | 4,224 |
| IPT\slide0001_image026.png | 21-Sep-00 | 1,933 |
| IPT\slide0001_image029.png | 21-Sep-00 | 102,658 |
| IPT\slide0001_image032.png | 21-Sep-00 | 9,782 |
| IPT\slide0002_image044.png | 21-Sep-00 | 38,740 |
| IPT\slide0014_image008.png | 21-Sep-00 | 28,915 |
| IPT\slide0014_image009.png | 21-Sep-00 | 32,876 |
| IPT\slide0014_image010.png | 21-Sep-00 | 17,980 |
| IPT\slide0014_image011.png | 21-Sep-00 | 193,577 |
| IPT\slide0014_image0 12.png | 21-Sep-00 | 99,093 |
| IPT\slide0014_image013.png | 21-Sep-00 | 30,693 |
| IPT\slide0014_image018.png | 21-Sep-00 | 7,030 |
| IPT\slide0014_image020.png | 21-Sep-00 | 330,774 |
| IPT\nspid.server 1 | 11-Jul-01 | 6 |
| IPT\nsmysql.so | 8-Jun-00 | 9,216 |
| IPT\create_tables.sql | 10-Jul-01 | 11,125 |
| IPT\delete.sql | 22-Jun-01 | 377 |
| IPT\drop.sql | 21-Jun-01 | 25 |
| IPT\select.sql | 6-Jul-01 | 880 |
| IPT\DATA.TAG | 4-Jul-00 | 187 |
| IPT\compat.tcl | 2-Aug-00 | 1,719 |
| IPT\debug.tcl | 2-Aug-00 | 4,674 |
| IPT\fastpath.tcl | 1-Aug-00 | 10,860 |
| IPT\file.tcl | 2-May-00 | 2,973 |
| IPT\form.tcl | 7-Jul-01 | 6,996 |
| IPT\http.tcl | 1-Aug-00 | 8,607 |
| IPT\init.tcl | 2-Aug-00 | 7,019 |
| IPT\iptutils.tcl | 11-Jul-01 | 63,813 |
| IPT\keygen.tcl | 13-Jul-00 | 13,719 |
| IPT\modlog.tcl | 2-Aug-00 | 26 |
| IPT\mynsd.tcl | 19-Sep-00 | 7,276 |
| IPT\namespace.tcl | 18-Aug-00 | 3,460 |
| IPT\nsd.tcl | 6-Sep-00 | 6,888 |
| IPT\nsdb.tcl | 2-Aug-00 | 7,754 |
| IPT\prodebug.tcl | 2-May-00 | 3,442 |
| IPT\sendmail.tcl | 2-Aug-00 | 6,062 |
| IPT\util.tcl | 2-Aug-00 | 9,632 |
| IPT\utilities.tcl | 24-Aug-00 | 115,410 |
| IPT\desc_file.txt | 21-Jun-01 | 87 |
| IPT\real_desc.txt | 5-Jul-01 | 265 |
| IPT\sonar12.groundtruth.txt | 5-Sep-00 | 3,540 |
| IPT\man.zip | 3-Jul-01 | 3,799 |
| IPT\sonar.zip | 5-Sep-00 | 9,305,158 |
| IPT\test_images.zip | 1-Sep-00 | 1,918,461 |
| IPT\test_mat_images.zip | 20-Jun-01 | 2,061,008 |
| IPT\preview.wmf | 21-Sep-00 | 20,644 |
| IPT\filelist.xml | 21-Sep-00 | 4,276 |
| IPT\master04.xml | 21-Sep-00 | 5,212 |
| IPT\master05.xml | 21-Sep-00 | 6,311 |
| IPT\pres.xml | 21-Sep-00 | 3,103 |
| IPT\slide0002.xml | 21-Sep-00 | 32,137 |
| IPT\slide0014.xml | 21-Sep-00 | 35,321 |
| SAP\image002.gif | 10-Sep-99 | 352 |
| SAP\image003.gif | 10-Sep-99 | 5,611 |
| SAP\image004.gif | 10-Sep-99 | 8,541 |
| SAP\image014.gif | 9-Sep-99 | 169 |
| SAP\FAQ_SAP.htm | 13-Sep-99 | 53,274 |
| SAP\SAPProgrammingTips.htm | 13-Sep-99 | 55,231 |
| SAP\SAPToolb.htm | 9-Sep-99 | 6,290 |
| SAP\SAPToolboxFeatures.htm | 9-Sep-99 | 32,382 |
| SAP\SAPToolboxFeaturesFrame.htm | 9-Sep-99 | 2,538 |
| SAP\SAPToolboxManual.htm | 10-Sep-99 | 18,233 |
| SAP\image002.jpg | 9-Sep-99 | 169 |
| SAP\image004.jpg | 9-Sep-99 | 169 |
| SAP\image006.jpg | 9-Sep-99 | 169 |
| SAP\image008.jpg | 9-Sep-99 | 169 |
| SAP\image010.jpg | 9-Sep-99 | 169 |
| SAP\image012.jpg | 9-Sep-99 | 169 |
| SAP\image016.jpg | 9-Sep-99 | 169 |
| SAP\BP_IF.M | 10-Sep-99 | 5,417 |
| SAP\Contents.m | 13-Sep-99 | 1,194 |
| SAP\CSA_IF.M | 10-Sep-99 | 9,262 |
| SAP\dflag.m | 10-Sep-99 | 979 |
| SAP\dual_apo.m | 10-Sep-99 | 1,947 |
| SAP\ENDIABLE.M | 10-Sep-99 | 1,772 |
| SAP\findInterpolated.m | 10-Sep-99 | 1,748 |
| SAP\help_sap.m | 13-Sep-99 | 655 |
| SAP\PFA_IF.M | 10-Sep-99 | 12,200 |
| SAP\pfa_via_FFT.m | 10-Sep-99 | 1,582 |
| SAP\pfa_via_fir.m | 10-Sep-99 | 1,737 |
| SAP\pfa_via_poly.m | 10-Sep-99 | 1,724 |
| SAP\rma_callback1.m | 10-Sep-99 | 1,122 |
| SAP\rma_callback2.m | 10-Sep-99 | 1,122 |
| SAP\RMA_IF.M | 10-Sep-99 | 13,840 |
| SAP\rma_if2.m | 10-Sep-99 | 13,596 |
| SAP\SAP_MAIN.M | 13-Sep-99 | 6,665 |
| SAP\SCN_GEN.M | 10-Sep-99 | 8,053 |
| SAP\sva_demo.m | 10-Sep-99 | 2,579 |
| SAP\VPH_GEN.M | 10-Sep-99 | 8,618 |
| SAP\oledata.mso | 10-Sep-99 | 2,560 |
| SAP\image001.png | 9-Sep-99 | 9,371 |
| SAP\image003.png | 9-Sep-99 | 53,926 |
| SAP\image005.png | 9-Sep-99 | 6,424 |
| SAP\image007.png | 9-Sep-99 | 10,670 |
| SAP\image009.png | 9-Sep-99 | 183,104 |
| SAP\image011.png | 9-Sep-99 | 324,501 |
| SAP\image015.png | 9-Sep-99 | 27,640 |
| SAP\image001.wmz | 10-Sep-99 | 385 |
| SAP\image003.wmz | 9-Sep-99 | 5,875 |
| SAP\image013 .wmz | 9-Sep-99 | 528 |
| SAP\filelist.xml | 10-Sep-99 | 307 |

A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND

This invention relates generally to a data processing apparatus and corresponding methods for the analysis of data stored in a database or as computer files and more particularly to a method for selecting appropriate algorithms based on data characteristics such as, for example, digital signal processing (“DSP”) and image processing (“IP”).

As bandwidth becomes more plentiful, data mining must be able to handle spatially and temporally sampled data, such as image and time-series data, respectively. DSP and IP algorithms transform raw time-series and image data into projection spaces, where good features can be extracted for data mining. The universe of the algorithm space is so vast that it is virtually impossible to try out every algorithm in an exhaustive fashion.

DSP relates generally to time series data. Time series data may be recorded by any conventional means, including, but not limited to, physical observation and data entry, or electronic sensors connected directly to a computer. One example of such time series data would be sonar readings taken over a period of time. A further example of such time series data would be financial data. Such financial data may typically be reported in conventional sources on a daily basis or may be continuously updated on a tick-by-tick basis. A number for algorithms are known for processing various types of time-series digital signal data in data mining applications.

IP relates generally to data representing a visual image. Image data may relate to a still photograph or the like, which has no temporal dimension and thus does not fall within the definition of digital signal time series data as customarily understood. In another embodiment, image data may also have a time series dimension such as in a moving picture or other series of images. One example of such a series of images would be mammograms taken over a period of time, where radiologists or other such users may desire to detect significant changes in the image. In general, an objective of IP algorithms is to maximize, as compactly as possible, useful information content concerning regions of interest in spatial, chromatic, or other applicable dimensions of the digital image data. A number of algorithms are known for processing various types of image data. Under certain situations, spatial sensor data require preprocessing to convert sensor time-series data into images. Examples of such spatial sensor data include radar, sonar, infrared, laser, and others. Examples of such preprocessing include synthetic-aperture processing and beam forming.

Currently known data-mining tools lack a generalized capability to process sampled data. Instead, techniques in the areas of DSP and IP explore specific approaches developed for different application areas. For example, some techniques explore a combination of autoregressive moving average time-series modeling (also known as linear predictive coding (“LPC”) in the speech community for the autoregressive portion) and a neural-network approach for econometric data analysis. As a further example, one commercially available economic data-mining application relies on vector autoregressive moving average with exogenous input for econometric time-series analysis. Other known techniques appear similar to sonar multi-resolution signal detectors, and may use a combination of the fast Fourier transform and Yule-Walker LPC analyses for time-series modeling of physiological polygraphic data, or propose a time-series pattern-matching system that relies on frame-based, geometric shape matching given training templates. Yule-Walker LPC is a standard technique in estimating autoregressive coefficients in, for example, speech coding. It uses time-series data rearranged in the form of a Toelpitz data matrix.

Still other known approaches, for example, use geometric and/or spectral features to find similar patterns in time-series data, or suggest a suite of processing algorithms for object classification, without the benefit of automatic algorithm selection. Known approaches, for example, describe an integrated approach to surface anomaly detection using various algorithms including IP algorithms. All these approaches explore a small subset in the gigantic universe of processing algorithms based on intuition and experience.

In difficult data-mining problems, the bulk of performance gain may be attributable to judicious preprocessing and feature extraction, not to the backend data mining. Because the search space of such preprocessing algorithms is comparatively extremely large, global optimization based on an exhaustive search is virtually impossible. Locally optimal solutions tend to be ad hoc and cover only a limited algorithm-search space depending on the level of algorithmic expertise of the user. These approaches do not take advantage of a prior performance database and differences in the level of algorithm complexity to allow rapid convergence to a globally optimal solution in selecting appropriate algorithms such as signal- and image-processing algorithms. Because of the aforementioned complexity, many data-mining tools neither provide guidance on how to process temporally and spatially sampled data nor are capable of processing sampled data. One embodiment disclosed herein automatically selects an appropriate set of DSP and IP algorithms based on problem context and data characteristics.

In general, known approaches provide specific algorithms dealing with special application areas. Some, for example, relate to algorithms that may be useful in analyzing physiological data. Others relate to algorithms that may be useful in analyzing econometric data. Still others relate to algorithms that may be useful in analyzing geometric data. Each of these approaches therefore explores a comparatively small subset of the algorithm space.

Known data mining tools lack a general capability to process sampled data without a priori knowledge about the problem domain. Even with prior knowledge about the problem domain, preprocessing can often be done only by algorithm experts. Such experts must write their own computer programs to convert sampled data into a set of feature vectors, which can then be processed by a data mining tool. The above described and other approaches in the areas of DSP and IP explore specific approaches developed for different application areas by algorithm experts.

A disadvantage of such approaches is that developing highly tailored DSP and IP algorithms for each application domain is painstakingly tedious and time consuming. Because such approaches are painstakingly tedious and time consuming, most developers looking for algorithms explore only a small subset of the algorithm universe. Exploring only a small subset of the algorithm universe may result in sub-optimal performance. Furthermore, the requirement for such algorithm expertise may prevents users from extracting the highest level of knowledge from their data in a cost-efficient manner.

There remains a need, therefore, for a solution that will, in at least some embodiments, automatically select appropriate algorithms based on the problem data set supplied and convert raw data into a set of features that can be mined.

### SUMMARY

The invention, together with the advantages thereof, may be understood by reference to the following description in conjunction with the accompanying figures, which illustrate some embodiments of the invention.

One embodiment is a method to identify a preprocessing algorithm for raw data. This method may include providing an algorithm knowledge database with preprocessing algorithm data and feature set data associated with the preprocessing algorithm data, analyzing raw data to produce analyzed data, extracting from the analyzed data features that characterize the data, and selecting a preprocessing algorithm using the algorithm knowledge database and features extracted from the analyzed data. The raw data may be DSP data or IP data. DSP data may be analyzed using TFR-space transformation, phase map representation, and/or detection/clustering. IP data may be analyzed using detection/segmentation and/or ROI shape characterization. The method may also include data preparation and/or evaluating the selected preprocessing algorithm. Data preparation may include conditioning/preprocessing, Constant False Alarm Rate (“CFAR”) processing, and/or adaptive integration. Conditioning/preprocessing may include interpolation, transformation, normalization, hardlimiting outliers, and/or softlimiting outliers. The method may also include updating the algorithm knowledge base after evaluating the selected preprocessing algorithm.

Another embodiment is a data mining system for identifying a preprocessing algorithm for raw data. The data mining system includes (i) at least one memory containing an algorithm knowledge database and raw data for processing and (ii) random access memory with a computer program stored in it. The random access memory is coupled to the other memory so that the random access memory is adapted to receive (a) a data analysis program to analyze raw data, (b) a feature extraction program to extract features from raw data, and (c) an algorithm selection program to identify a preprocessing algorithm. It is not necessary that the algorithm knowledge database and the raw data exist simultaneously on just one memory. In an alternative embodiment, the algorithm knowledge database and the raw data for processing may be contained in and spread across a plurality of memories. These memories may be any type of memory known in the art including, but not limited to, hard disks, magnetic tape, punched paper, a floppy diskette, a CD-ROM, a DVD-ROM, RAM memory, a remote site accessible by any known protocall, or any other memory device for storing data. The data analysis program may include a DSP data analysis program and/or an IP data analysis program. The DSP data analysis program may be able to perform TFR-space transformation, phase map representation, and/or detection/clustering. The IP data analysis program may be able to perform detection/segmentation and/or ROI shape characterization. The random access memory may also receive a data preparation subprogram and/or an algorithm evaluation subprogram. The data preparation program may include a conditioning/preprocessing subprogram, a CFAR processing subprogram, and/or an adaptive integration subprogram. The conditioning/preprocessing subprogram may includes interpolation, transformation, normalization, hardlimiting outliers, and/or softlimiting outliers. The algorithm evaluation program may update the algorithm knowledge database contained in the memory.

Another embodiment is a data mining application that includes (a) an algorithm knowledge database containing preprocessing algorithm data and feature set data associated with the preprocessing algorithm data; (b) a data analysis module adapted to receive control of the data mining application when the data mining application begins; (c) a feature extraction module adapted to receive control of the data mining application from the data analysis module and available to identify a set of features; and (d) an algorithm selection module available to receive control from the feature extraction module and available to identify a preprocessing algorithm based upon the set of features identified by the feature extraction module using the algorithm knowledge database. The algorithm selection module may select a DSP algorithm and/or an IP algorithm. The algorithm selection module may use energy compaction capabilities, discrimination capabilities, and/or correlation capabilities. The data analysis module may use a short-time Fourier transform coupled with LPC analysis, a compressed phase-map representation, and/or a detection/clustering process if the data selection process will select a DSP algorithm. The data analysis module may use a procedure operable to provide at least one a ROI by segmentation, a procedure to extract local shape related features from a ROI; a procedure to extract two-dimensional wavelet features characterizing a ROI; and/or a procedure to extract global features characterizing all ROIs if the algorithm selection module will select an IP algorithm. The detection/clustering process may be an expectation maximization algorithm or may include procedures that set a hit detection threshold, identify phase-space map tiles, count hits in each identified phase-space map tile, and detect the phase-space map tiles for which the hits counted exceeds the hit detection threshold. The data mining application may also include an advanced feature extraction module available to receive control from the algorithm selection module and to identify more features for inclusion in the set of features. It may also include a data preparation module available to receive control after the data mining application begins, in which case the data analysis module is available to receive control from the data preparation module. It may also include an algorithm evaluation module that evaluates performance of the preprocessing algorithm identified by the algorithm selection module and which may update the algorithm knowledge database. The data preparation module may include a conditioning/preprocessing process, a CFAR processing process and/or an adaptive integration process. The conditioning/preprocessing process may perform interpolation, transformation, normalization, hardlimiting outliers, and/or softlimiting outliers. Adaptive integration may include subspace filtering and/or kernel smoothing.

Another embodiment is a data mining product embedded in a computer readable medium. This embodiment includes at least one computer readable medium with an algorithm knowledge database embedded in it and with computer readable program code embedded in it to identify a preprocessing algorithm for raw data. The computer readable program code in the data mining product includes computer readable program code for data analysis to produce analyzed data from the raw data, computer readable program code for feature extraction to identify a feature set from the analyzed data, and computer readable program code for algorithm selection to identify a preprocessing algorithm using the analyzed data and the algorithm knowledge database. The computer readable program code may also include computer readable program code for algorithm evaluation to evaluate the preprocessing algorithm selected by the computer readable program code for algorithm selection. The data mining product need not be contained on a single article of media and may be embedded in a plurality of computer readable media. The computer readable program code for data analysis may include computer readable program code for DSP data analysis and/or computer readable program code for IP data analysis. The computer readable program code for DSP data analysis may include computer readable program code for TFR-space transformation, computer readable program code for phase map representation and/or computer readable program code for detection/clustering. The computer readable program code for IP data analysis may include computer readable program code for detection/segmentation and/or computer readable program code for ROI shape characterization. The computer readable program code for algorithm evaluation may be operable to modify the algorithm knowledge database. The data mining product may also include computer readable program code for data preparation to produce prepared data from the raw data, in which the computer readable program code for data analysis operates on the raw data after it has been transformed into the prepared data. The computer readable program code for data preparation may include computer readable program code for conditioning/preprocessing, computer readable program code for CFAR processing, and/or computer readable program code for adaptive integration. The computer readable program code for conditioning/preprocessing may include computer readable program code for interpolation, computer readable program code for transformation, computer readable program code for normalization, computer readable program code for hardlimiting outliers, and/or computer readable program code for softlimiting outliers.

### REFERENCE TO THE DRAWINGS

Several features of the present invention are further described in connection with the accompanying drawings in which:

FIG. 1 is a program flowchart that generally depicts the sequence of operations in an exemplary program for automatic mapping of raw data to a processing algorithm.

FIG. 2 is a data flowchart that generally depicts the path of data and the processing steps for an example of a process for automatic mapping of raw data to a processing algorithm.

FIG. 3 is a system flowchart that generally depicts the flow of operations and data flow of one embodiment of a system for automatic mapping of raw data to a processing algorithm.

FIG. 4 is a program flowchart that generally depicts the sequence of operations in an exemplary program for data preparation.

FIG. 5 is a program flowchart that generally depicts the sequence of operations in an example of a program for data conditioning/preprocessing.

FIG. 6 is a block diagram that generally depicts a configuration of one embodiment of hardware suitable for automatic mapping of raw data to a processing algorithm.

FIG. 7 is a program flowchart that generally depicts the sequence of operations in one example of a program for automatic mapping of DSP data to a processing algorithm.

FIG. 8 is a data flowchart that generally depicts the path of data and the processing steps for one embodiment of automatic mapping of DSP data to a processing algorithm.

FIG. 9 is a system flowchart that generally depicts the flow of operations and data flow of a system for one embodiment of automatic mapping of DSP data to a processing algorithm.

FIG. 10 is a program flowchart that generally depicts the sequence of operations in an exemplary program for automatic mapping of image data to a processing algorithm.

FIG. 11 is a data flowchart that generally depicts the path of data and the processing steps for one embodiment of automatic mapping of image data to a processing algorithm.

FIG. 12 is a system flowchart that generally depicts the flow of operations and data flow of one embodiment of a system for automatic mapping of image data to a processing algorithm.

### DESCRIPTIONS OF EXEMPLARY EMBODIMENTS

While the present invention is susceptible of embodiment in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In one embodiment, a data mining system and method selects appropriate digital signal processing (“DSP”) and image processing (“IP”) algorithms based on data characteristics. One embodiment identifies preprocessing algorithms based on data characteristics regardless of application areas. Another embodiment quantifies algorithm effectiveness using discrimination, correlation and energy compaction measures to update continuously a knowledge database that improves algorithm performance over time. The embodiments may be combined in one combination embodiment.

In another embodiment, there is provided for time-series data a set of candidate DSP algorithms. The nature of a query posed regarding the time-series data will define a problem domain. Examples of such problem domains include demand forecasting, prediction, profitability analysis, dynamic customer relationship management (CRM), and others. As a function of problem domain and data characteristics, the number of acceptable DSP algorithms is reduced. DSP algorithms selected from this reduced set may be used to extract features that will succinctly summarize the underlying sampled data. The algorithm evaluates the effectiveness of each DSP algorithm in terms of how compactly it captures information present in raw data and how much separation the derived features provide in terms of differentiating different outcomes of the dependent variable. The same logic may be applied to IP. While the concept of class separation has been generally applied to classification (categorical processing), it is nonetheless applicable to prediction and regression because continuous outputs can be converted to discrete variables for approximate reasoning using the concept of class separation. In an embodiment where the dependent variable remains continuous, the more appropriate performance measure will be correlation, not discrimination.

In another embodiment, raw time-series and image input data can be processed through low-complexity signal-processing and image-processing algorithms in order to extract representative features. The low-complexity features assist in characterizing the underlying data in a computationally inexpensive manner. The low-complexity features may then be ranked based on their importance. The effective low-complexity features will then be a subset including low complexity features of high ranking and importance. There is provided a performance database containing a historical record indicating how well various image- and signal-processing algorithms performed on various types of data. Feature association next occurs in order to identify high-complexity features that have worked well consistently with the effective low-complexity features previously computed. Next, there are identified high-complexity signal- and image-processing algorithms from which the associated high-complexity features were extracted. Then the identified high-complexity algorithms are used in preprocessing to improve data-mining performance further iteratively. This procedure can work on an arbitrary level of granularity in algorithm complexity.

An embodiment may initially perform computationally efficient processing in order to extract a set of features that characterizes the underlying macro and micro trends in data. These features provide much insight into the type of appropriate processing algorithms regardless of application areas and algorithm complexity. Thus, the data mining application in one embodiment may be freed of the requirement of any prior knowledge regarding the nature of the problem set domain.

An example of one aspect of data mining operations that may be automated by one embodiment of the invention is automatic recommendation of advanced DSP and IP algorithms by finding a meaningful relationship between signal/image characteristics and appropriate processing algorithms from a performance database As a further example, another aspect of data mining operations that may be automated by one embodiment of the invention is DSP-based and/or IP-based preprocessing tools that automatically summarize information embedded in raw time-series and image data and quantify the effectiveness of each algorithm based on a combined measure of energy compaction and class separation or correlation.

One embodiment the invention disclosed and claimed herein may be used, for example, as part of a complete data mining solution usable in solving more advanced applications. One example of such an advanced application would be seismic data analysis. A further example of such an advanced application would be sonar, radar, IR, or LIDAR sensor data processing.

One embodiment of this invention characterizes data using a feature vector and helps the user find a small number of appropriate DSP and IP algorithms for feature extraction.

An embodiment of the invention comprises a data mining application with improved high-complexity preprocessing algorithm selection, the data mining application comprising an algorithm knowledge database including preprocessing algorithm data and feature set data associated with the preprocessing algorithm data; a data analysis module that is available to receive control after the data mining application begins; a feature extraction module that is available to receive control from the data analysis module and that is available to identify a set of features; and an algorithm selection module that is available to receive control from the feature extraction module and that is available to identify a preprocessing algorithm based upon the set of features identified by the feature extraction module using the algorithm knowledge database. The algorithm selection module may select a DSP algorithm using energy compaction, discrimination, and/or correlation capabilities. The data analysis module may use a short-time Fourier transform, a compressed phase-map representation, and/or a detection/clustering process. The detection/clustering process can include procedures that for setting a hit detection threshold, identifying phase-space map tiles, counting hits in each identified phase-space map tile, and/or detecting the phase-space map tiles for which the number of hits counted exceeds the hit detection threshold using an expectation maximization algorithm. The algorithm selection module may select an IP algorithm using energy compaction, discrimination, and/or correlation capabilities to select an IP algorithm. The data analysis module for an IP algorithm may comprise a procedure to provide at least one a region of interest by segmentation and at least one procedure selected from the set of procedures including: a procedure to extract local shape related features from a region of interest; a procedure to extract two-dimensional wavelet features characterizing a region of interest; and a procedure to extract global features characterizing all regions of interest. The data mining application may also include an advanced feature extraction module available to receive control from the algorithm selection module and to identify more features for inclusion in the set of features and/or a data preparation module that is available to receive control after the data mining application begins, wherein the data analysis module is available to receive control from the data preparation module. The data analysis module may include conditioning/preprocessing, interpolation, transformation, and normalization. The conditioning/preprocessing process may perform adaptive integration. The data preparation module may include a CFAR processing process to identify and extract long term trend lines and adaptive integration, including subspace filtering and kernel smoothing. The data mining application may also include an algorithm evaluation module that evaluates performance of the preprocessing algorithm identified by the algorithm selection module and updates the algorithm knowledge database.

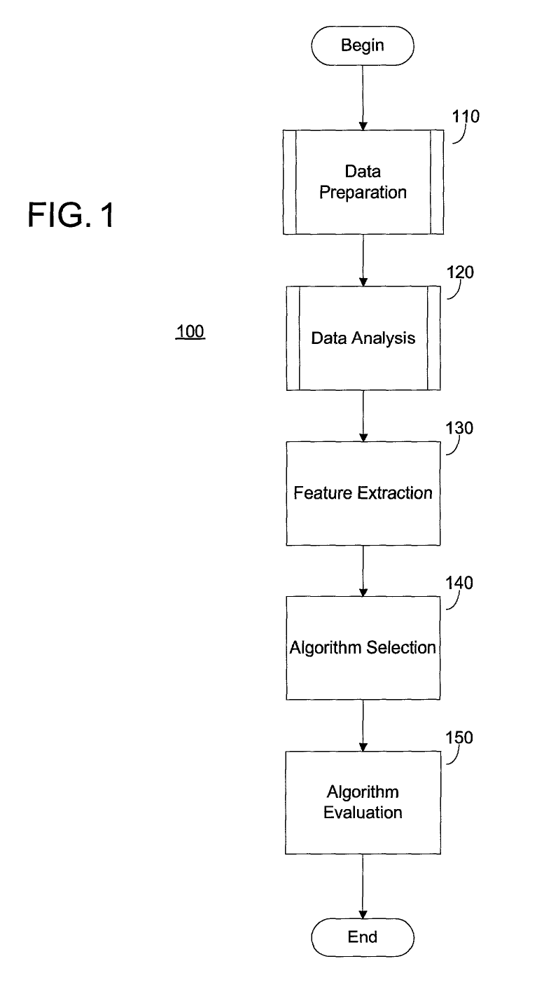

Referring now to FIG. 1, there is illustrated a flowchart of an exemplary embodiment of a raw data mapping program (100) to map raw data automatically to an advanced preprocessing algorithm, which depicts the sequence of operations to map raw data automatically to an advanced preprocessing algorithm. When it begins, the raw data mapping program (100) initially calls a data preparation process (110). The data preparation process (110) can perform simple functions to prepare data for more sophisticated DSP or IP algorithms. Examples of the kinds of simple functions performed by the data preparation process (110) may include conditioning/preprocessing, constant false alarm rate (“CFAR”) processing, or adaptive integration. Some may perform wavelet-based multi-resolution analysis as part of preprocessing. In speech processing, preprocessing may include speech/non-speech separation. Speech/non-speech separation in essence uses LPC and spectral features to eliminate non-speech regions. Non-speech regions may include, for example, phone ringing, machinery noise, etc. Highly domain-specific algorithms can be added later as part of feature extraction and data mining.

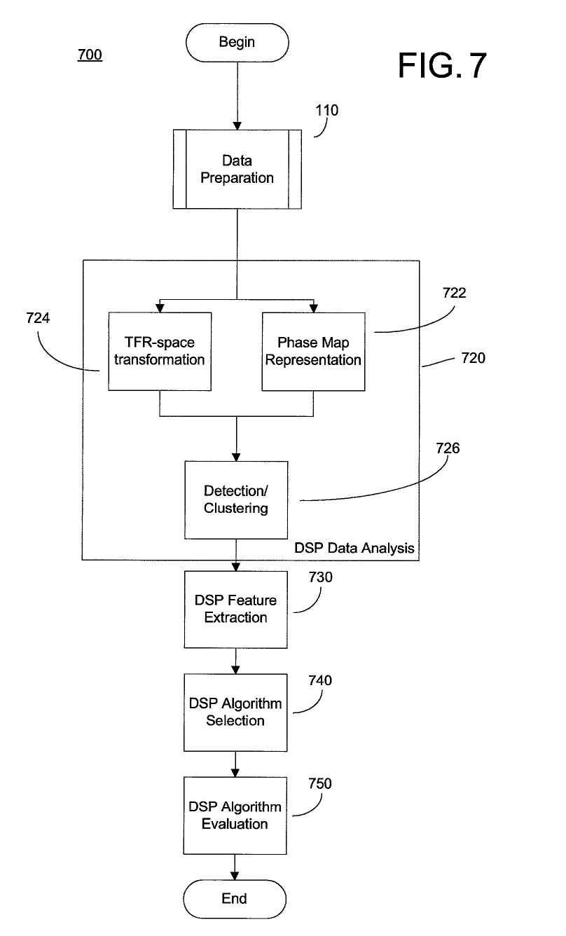

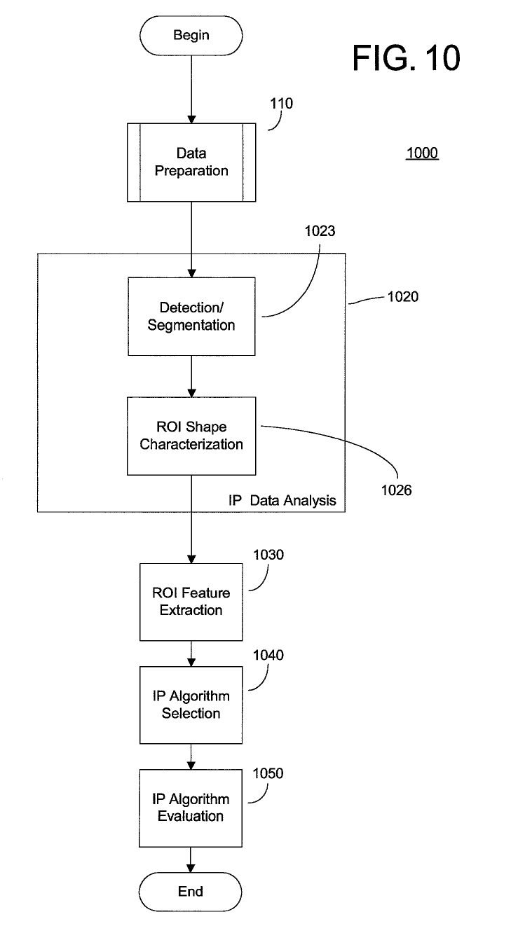

Referring still to the example illustrated in FIG. 1, when the data preparation process (110) completes, it calls a data analysis process (120). In one embodiment, for DSP data, the data analysis process (120) can perform functions such as time frequency representation space (“TFR-space”) transformation, phase map representation, and detection/clustering. Certain embodiments of processes to perform these exemplary functions for DSP data are further described below in connection with FIG. 7. In another embodiment, for IP data the data analysis process (120) can perform functions such as detection/segmentation and region of interest (“ROI”) shape characterization. Certain embodiments of processes to perform these exemplary functions for IP data are further described below in connection with FIG. 10.

Referring still to the illustrated embodiment in FIG. 1, when the data analysis process (120) completes, it calls a feature extraction process (130). The feature extraction process (130) extracts features that characterize the underlying data and may be useful to select an appropriate preprocessing algorithm. For example, an embodiment of the feature extraction process (130) may operate to identify features in DSP data such as a sinusoidal event or exponentially damped sinusoids or significant inflection points or anomalous events or predefined spatio-temporal patterns in a template database. Another embodiment of the feature extraction process (130) may operate to identify features in IP data such as shape, texture, and intensity.

As shown in FIG. 1, when the feature extraction process (130) of the illustrated example completes, it calls an algorithm selection process (140). The actual selection is based on a knowledge database that keeps track of which algorithms work best given the global-feature distribution and local-feature distribution. Global feature distribution concerns the distribution of features over an entire event or all events, whereas local feature distribution concerns the distribution of features from frame to frame or tick to tick, as in speech recognition. The objective function for the algorithm selection process (140) is based on how well features derived from each algorithm achieve energy compaction and discriminate among or correlate with output classes. The actual algorithm selection process (140) for algorithm selection based on the local and global features may perform using any of the known solution methods. For example, the algorithm selection process (140) may be based on a family of hierarchical pruning classifiers. Hierarchical pruning classifiers operate by continuous optimization of confusing hypercubes in the feature vector space sequentially. Instead of giving up after the first attempt at classification, a set of hierarchical sequential pruning classifiers can be created. The first-stage feature-classifier combination can operate on the original data set to the extent possible. Next, the regions with high overlap are identified as “confusing” hypercubes in a multi-dimensional feature space. The second-stage feature-classifier combination can then be designed by optimizing parameters over the surviving feature tokens in the confusing hypercubes. At this stage, easily separable feature tokens have been discarded from the original feature set. These steps can be repeated until a desired performance is met or the number of surviving feature tokens falls below a preset threshold.

Referring to the embodiment of FIG. 1, when the algorithm selection process (140) completes it calls an algorithm evaluation process (150) as shown. The data used by the algorithm selection process (140) are continuously updated by self-critiquing the selections made. Each algorithm may be evaluated based on any suitable measure for evaluating the selection including, for example, energy compaction and discrimination or correlation capabilities.

Energy compaction criterion measures how well the signal-energy spread over multiple time samples can be captured in a small number of transform coefficients. Energy compaction may be measured by computing the amount of energy being captured by transform coefficients as a function of the number of transform coefficients. For instance, a transform algorithm that captures 90% of energy with the top three transform coefficients in time-series samples is superior to another transform algorithm that captures 70% of energy with the top three coefficients. Energy compaction is measured for each transform algorithm, which generates a set of transform coefficients. For instance, the Fourier transform has a family of sinusoidal basis functions, which transform time-series data into a set of frequency coefficients (i.e., transform coefficients). The less the number of transform coefficients with large magnitudes, the more energy compaction a transform algorithm achieves. Discrimination criteria assess the ability of features derived from each algorithm to differentiate target classes. Discrimination measures the ability of features derived from a transform algorithm to differentiate different target outcomes. In general, discrimination and energy compaction can go hand in hand based purely on probability arguments. Nevertheless, it may be desirable to combine the two in assessing the efficacy of a transform algorithm in data mining. Discrimination is directly proportional to how well an input feature separates various target outcomes. For a two-class problem, for example, discrimination is measured by calculating the level of overlap between the two class-conditional feature probability density functions. Correlation criteria evaluate the ability of features to track the continuous target variable with an arbitrary amount of time lag. After completing the algorithm evaluation process (150), the exemplary program illustrated in FIG. 1 may end, as shown.

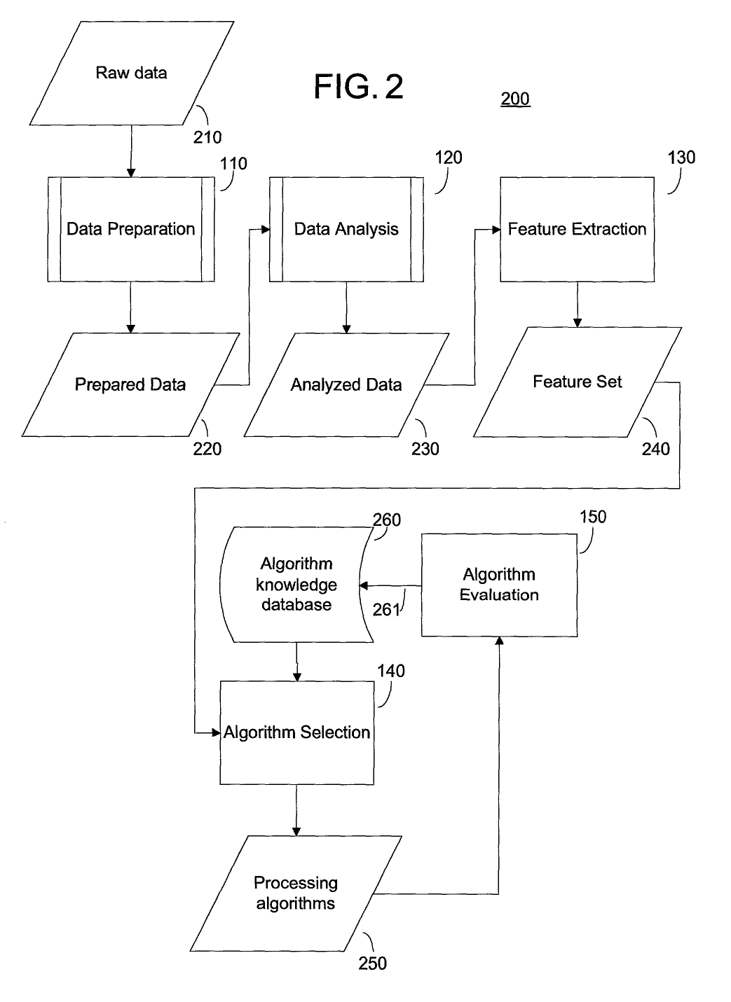

Referring next to FIG. 2, there is disclosed a data flowchart that generally depicts the path of data and the processing steps for an example of a process (200) for automatic mapping of raw data to a processing algorithm. As shown, the process (200) begins with raw data (210), in whatever form. Raw data may be found in an existing database, or may be collected through automated monitoring equipment, or may be keyed in by manual data entry. Raw data can be in the form of Binary Large Objects (BLOBs) or one-to-many fields in the context of object-relational database. In other instances, raw data can be stored in a file structure. Highly normalized table structures in an object-oriented database may store such raw data in an efficient structure. Raw data examples include, but are not limited to, mammogram image data, daily sales data, macroeconomic data (such as the consumer confidence index, Economic Cycle Research Institute index, and others) as a function of time, and so on. The specific form and media of the data are not material to this invention. It is expected that it may be desirable to put the raw data (210) in a machine readable and accessible form by some suitable process.

Referring still to the exemplary process (200) illustrated in FIG. 2, the raw data (210) flows to and is operated on by the data preparation process (110). Examples of the kinds of simple functions performed by the data preparation process (110) may include conditioning/preprocessing, CFAR processing, or adaptive integration. After the raw data (210) are subjected to these various functions or any of them, the result is a set of prepared data (220). The prepared data (220) flows to and is operated on by the data analysis process (120). In an embodiment in which the prepared data (220) is DSP data, the data analysis process (120) may perform the functions of TFR-space transformation, phase map representation, and detection/clustering, examples of which are further described in the embodiment depicted in FIG. 7. In another embodiment in which the prepared data (220) is IP data, the data analysis process (120) may perform the functions of detection/segmentation and ROI shape characterization, examples of which are further described in the embodiment depicted in FIG. 10. The result is that prepared data (220), whether DSP data or IP data, is transformed into analyzed data (230) which is descriptive of the characteristics of the prepared data (220).

In the example process (200) illustrated in FIG. 2, the analyzed data (230) flows to and is operated on by the feature extraction process (130), which extracts local and global features. For example, in an embodiment that operates on raw data (210) that is DSP data, the feature extraction process (130) may characterize the time-frequency distribution and phase-map space. As another example, in an embodiment that operates on raw data (210) that is IP data, the feature extraction process (130) may characterize features such as texture, shape, and intensity. The result in the illustrated embodiment will be feature set data (240) containing information that characterizes the raw data (210) as transformed into prepared data (220) and analyzed data (230).

Referring still to the example of FIG. 2, feature set data (240) flows to and is operated on by the algorithm selection process (140), which in the illustrated embodiment performs its processing using information stored in an existing algorithm knowledge database (260). The actual algorithm knowledge database (260) in this example may be based on how each algorithm contributes to energy compaction and discrimination in classification or correlation in regression. The algorithm knowledge database (260) may be filled based on experiences with knowledge extraction from various time-series and image data. The algorithm selection process (140) identifies processing algorithms (250). These processing algorithms (250) then flow to and are operated upon by the algorithm evaluation process (150), which in turn updates the algorithm knowledge database (260) as illustrated by line 261. The final output of the program is, first, the processing algorithms (250) that will be used by a data mining application to analyze data and, second, an updated algorithm knowledge database (260), that will be used for future mapping of raw data (210) to processing algorithms (250)

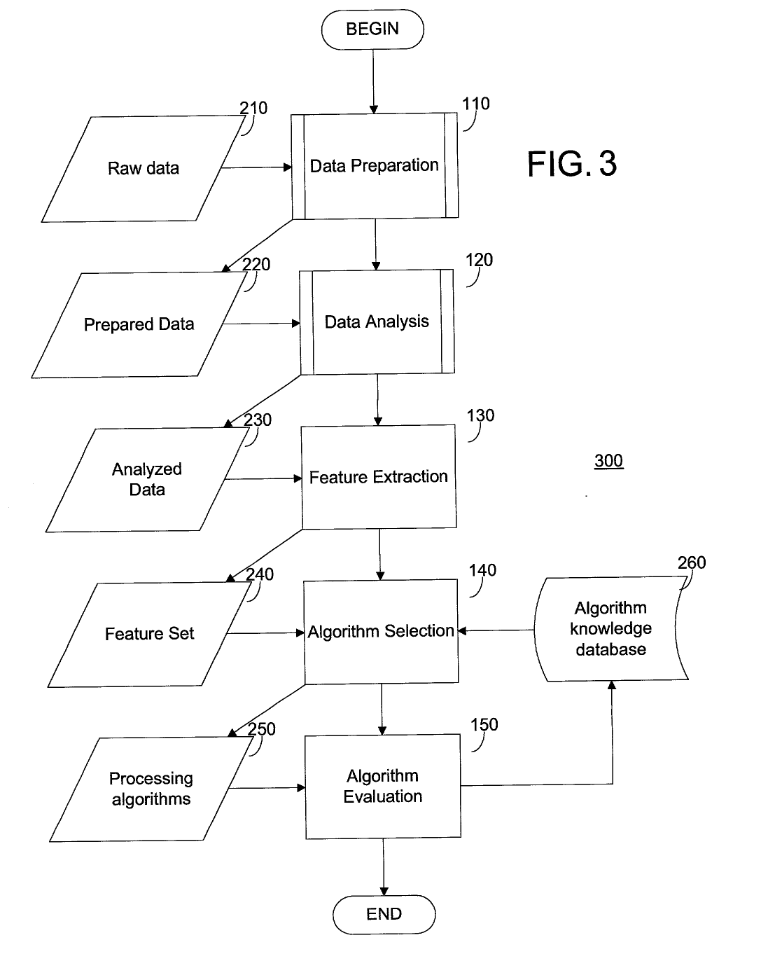

Referring next to FIG. 3, there is shown a system flowchart that generally depicts the flow of operations and data flow of an embodiment of a system (300) for automatic mapping of raw data to a processing algorithm. This FIG. 3 depicts not only data flow, but also control flow between processes for the illustrated embodiments. The individual data symbols, indicating the existence of data, and process symbols, indicating the operations to be performed on data, are described further in connection with FIG. 1 above and FIG. 2 above. When it begins, this example process (300) initially calls a data preparation process (110). The data preparation process (110) operates on raw data (210) to produce prepared data (220), then when it is finished calls the data analysis process (120). The data analysis process (120) operates on prepared data (220) to produce analyzed data (230), then when it is finished calls the feature extraction process (130). The feature extraction process (130) operates on analyzed data (230) to produce feature set data (240), then when it is finished calls the algorithm selection process (140). The algorithm selection process (140) uses the algorithm knowledge database (260) and operates on the feature set data (240) to identify processing algorithms (250), then when it is finished calls the algorithm evaluation process (150). The algorithm evaluation process (150) evaluates the identified processing algorithms (250), then uses the results of its evaluation to update the algorithm knowledge database (260) in the embodiment illustrated in FIG. 3. In another embodiment (not shown) an algorithm knowledge database may be predetermined and not updated. After the algorithm evaluation process (150) completes, the program may end.

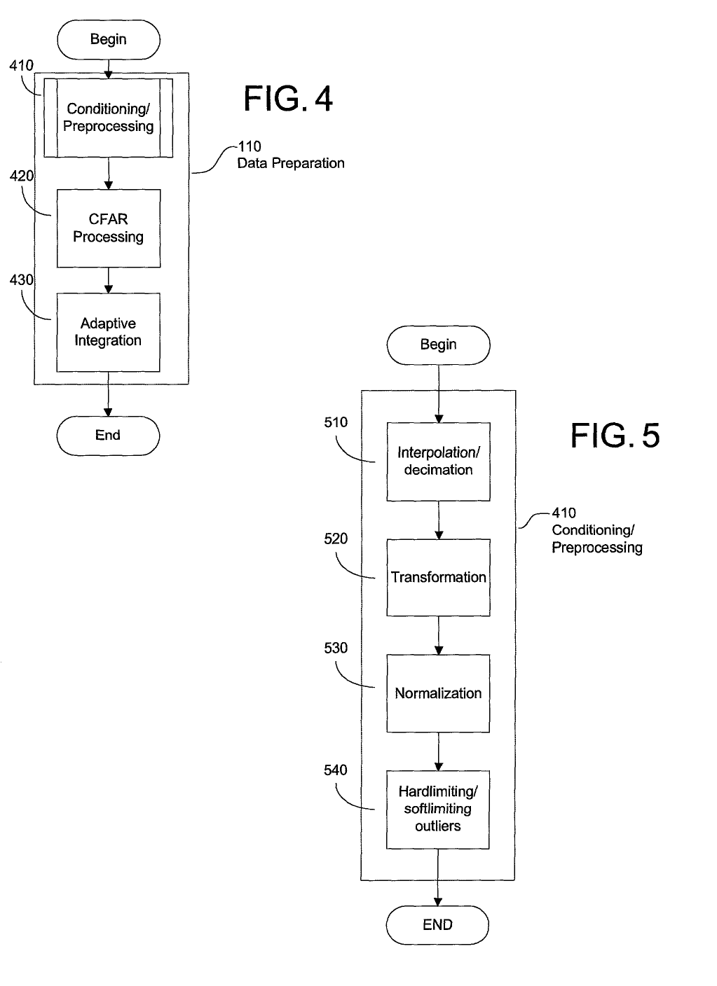

Referring next to FIG. 4, there is disclosed a program flowchart depicting a specific example of a suitable data preparation process (110). This data preparation process (110) performs a series of preferably computationally inexpensive operations to render data more suitable for processing by other algorithms in order better to identify data mining preprocessing algorithms. Before using relatively more sophisticated DSP or IP algorithms, it may be advantageous first to process the raw time series or image data through relatively low complexity DSP and IP algorithms. The relatively low complexity DSP and IP algorithms may assist in extracting representative features. These low complexity features may also assist in characterizing the underlying data. One benefit of an embodiment of this invention including such relatively low-complexity preprocessing algorithms is that this approach to characterizing the underlying data is relatively inexpensive computationally.

When the embodiment of the data preparation process (110) illustrated in FIG. 4 begins, it calls first a conditioning/preprocessing process (410). The conditioning/preprocessing process (110) may perform various functions including interpolation/decimation, transformation, normalization, and hardlimiting or softlimiting outliers. These functions of the conditioning/preprocessing process (410) may serve to fill in missing values and provide for more meaningful processing.

Referring still to the example of FIG. 4, when the data preparation process (110) ends, it calls a constant false alarm-rate (“CFAR”) processing process (420), which may operate to eliminate long term trend lines and seasonal fluctuations. The CFAR processing process (420) may further operate to accentuate sharp deviations from recent norm. When long term trend lines are eliminated and sharp deviations from recent norms are accentuated, later processing algorithms can focus more accurately and precisely on transient events of high significance that may mark the onset of a major trend reversal. In an embodiment including a CFAR processing process (420), long term trends may be annotated as up or down with slope to eliminate long term trend lines while emphasizing sharp deviations from recent norms. One example of CFAR processing involves the following three steps: (1) estimation of local noise statistics around the test token, (2) elimination of outliers from the calculation of local noise statistics, and (3) normalization of the test token by the estimated local noise statistics. The output data is a normalized version of the input data.

The constant-false-alarm-rate processing process (420) may identify critical points in the data. Such a critical point may reflect, for example, an inflection point in the variable to be predicted. As a further example, such a critical point may correspond to a transient event in the observed data. In general, the signals comprising data indicating these critical points may be interspersed with noise comprising other data corresponding to random fluctuations. It may be desirable to improve the signal-to-noise ratio in the data set through an additional processing step.

Because the CFAR processing process (420) tends to amplify small perturbations in data, the effect of small, random fluctuations may be exaggerated. It may therefore be desirable in some embodiments to reduce the sensitivity of the processing to fluctuations reflected in only one or a similarly comparatively very small number of observations. Referring still to the embodiment illustrated in FIG. 4, when the CFAR processing process (420) ends, it calls an adaptive integration process (430) to improve the signal-to-noise ratio of inflection or transient events. The adaptive integration process (430) may, for example, perform subspace filtering to separate data into signal and alternative subspaces. The adaptive integration process (430) may also perform smoothing, for example, Viterbi line integration and/or kernel smoothing, so that the detection process is not overly sensitive to small, tick-by-tick fluctuations. Adaptive integration may perform trend-dependent integration and is particularly useful in tracking time-varying frequency line structures such as may occur in speech and sonar processing. It can keep track of line trends over time and hypothesize where the new lines should continue, thereby adjusting integration over energy and space accordingly. Typical integration cannot accommodate such dynamic behaviors in data structure. Subspace filtering utilizes the singular value decomposition to divide data into signal subspace and alternate (noise) subspace. This filtering allows focus on the data structure responsible for the signal component. Kernel smoothing uses a kernel function to perform interpolation around a test token. The smoothing results can be summed over multiple test tokens so that the overall probability density function is considerably smoother than the one derived from a simple histogram by hit counting.

Referring now to FIG. 5, there is disclosed a program flowchart depicting an example of a process that may be performed as part of the conditioning/preprocessing process (410). In one embodiment, when the conditioning/preprocessing process (410) begins, it first calls an interpolation process (510). Interpolation can be linear, quadratic, or highly nonlinear (quadratic is nonlinear) through transformation. An example of such nonlinear transformation is Stolt interpolation in synthetic-aperture radar with spotlight processing. In general, the nearest N samples to the time point desired to be estimated are found and interpolation or oversampling is used to fill-in the missing time sample. The interpolation process (510) may be used in the conditioning module to fill in missing values and to align samples in time if sampling intervals differ. When the interpolation process (510) ends, it calls a transformation process (520), which transforms data from one space into another. Transformation may encompassfor example, difference output, scaling, nonlinear mathematical transformation, composite-index generation based on multiple channel data.

The transformation process (520) may then call a normalization process (530) for more meaningful processing. For example, in an embodiment analyzing financial data, the financial data may be transformed by the transformation process (520) and normalized by the normalization process (530) for more meaningful interpretation of macro trends not biased by short-term fluctuations, demographics, and inflation. Transformation and normalization do not have to occur together, but they generally complement each other. Normalization eliminates long-term trends (and may therefore be useful in dealing with non-stationary noise) and accentuates momentum-changing events, while transformation maps input data samples in the input space to transform coefficients in the transform space. Normalization can detrend data to eliminate long-term easily predictable patterns. For instance, the stock market may tend to increase in the long term. Some may be interested in inflection points, which can be accentuated with normalization. Transformation maps data from one space to another. When the normalization process (530) ends control in the example of FIG. 5 may then flow to a hardlimiting/softlimiting outliers process (540).

The hardlimiting/softlimiting outliers process (540) may act to confine observations within certain boundaries so as to restrict exaggerated effects from isolated, extreme observations by clipping or transformation. Outliers are defined as those that are far different from the norm. They can be identified in terms of Euclidean distance. That is, if a distance between the centroid and a scalar or vector test token normalized by variance for scalar or covariance matrix for vector attributes exceeds a certain threshold, then the test token is labeled as an outlier and can be thrown out or replaced. Replacing all the outliers with the same value is hardlimiting, while softlimiting assigns a much smaller dynamic range in mapping the outliers to a set of numbers (i.e., hyperbolic tangent, sigmoid, log, etc.). A standard set of parameters will be provided for novice users, while expert users can change their values. When the hardlimiting/softlimiting outliers process (540) concludes, the illustrated conditioning/preprocessing process (410) ends. It is not necessary that each of these processes be performed for conditioning/preprocessing, nor is it required that they be performed in this specific order. For example, in another embodiment of the conditioning/preprocessing process (410), the interpolation/decimation process (510) or any of the other processes (520) (530) (540) may be omitted. In still another embodiment of the conditioning preprocessing process (410), the hardlimiting/softlimiting outliers process (540) may be called first rather than last. Other sequences and combinations are possible, and are considered to be equivalent to the specific embodiments here described, as are all other low complexity conditioning/preprocessing algorithms now know or hereafter developed.

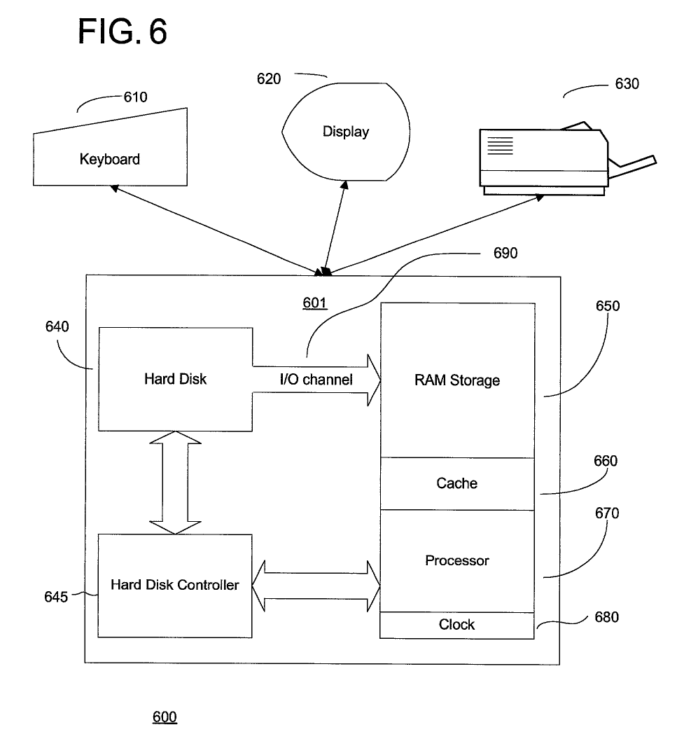

Referring now to FIG. 6, there is disclosed a block diagram that generally depicts an example of a configuration (600) of hardware suitable for automatic mapping of raw data to a processing algorithm. A general-purpose digital computer (601) includes a hard disk (640), a hard disk controller (645), ram storage (650), an optional cache (660), a processor (670), a clock (680), and various I/O channels (690). In one embodiment, the hard disk (640) will store data mining application software, raw data for data mining, and an algorithm knowledge database. Many different types of storage devices may be used and are considered equivalent to the hard disk (640), including but not limited to a floppy disk, a CD-ROM, a DVD-ROM, an online web site, tape storage, and compact flash storage. In other embodiments not shown, some or all of these units may be stored, accessed, or used off-site, as, for example, by an internet connection. The I/O channels (690) are communications channels whereby information is transmitted between RAM storage and the storage devices such as the hard disk (640). The general-purpose digital computer (601) may also include peripheral devices such as, for example, a keyboard (610), a display (620), or a printer (630) for providing run-time interaction and/or receiving results. Prototype software has been tested on Windows 2000 and Unix workstations. It is currently written in Matlab and C/C++. Two embodiments are currently envisioned—client server and browser-enabled. Both versions will communicate with the back-end relational database servers through ODBC (Object Database Connectivity) using a pool of persistent database connections.

Referring now to FIG. 7, there is disclosed a program flowchart of an exemplary embodiment of a DSP data mapping program (700). When the DSP data mapping program begins it calls a data preparation process (110) to perform simple functions such as conditioning/preprocessing, CFAR processing, or adaptive integration. This data preparation process may fill, smooth, transform, and normalize DSP data. When the data preparation process (110) has completed, it calls a DSP data analysis process (720). This illustrated DSP data analysis process (720) is one embodiment of a general data analysis process (120) described above in connection with FIG. 1.

TFR-space relates generally to the spectral distribution of how significant events occur over time. The DSP data analysis process (720) may include a TFR-space transformation sub-process (724) activated as part of the DSP data analysis process (720). In one embodiment of the DSP data mapping program (700), the TFR-space transformation sub-process (724) may use the short-time Fourier transform (“STFT”). An advantage of the STFT (in those embodiments using the STFT) is that it is more computationally efficient than other more elaborate tine-frequency representation algorithms. The STFT applies the Fourier transform to each frame. The entire time-series data is divided into multiple overlapping time frames, where each frame spans a small subset of the entire data. Each time frame is converted into transform coefficients. Essentially, an N-point time series is mapped onto an M-by-(N*2/M−1) matrix (with 50% overlap between the two consecutive time frames), where M is the number of time samples in each frame. For instance, a 1024-point time series can be converted into a 64-by-31 TFR matrix with 50% overlap and 64-point FFT (M=64). On the other hand, LPC analysis can reduce 64-FFT coefficients to a much smaller set for even greater compression if the input data exhibit harmonic frequency structures. Other TFR functions include quadratic functions such as Wigner-Ville, Reduced Interference Distribution, Choi-Williams Distribution, and others. Still other TFR functions include a highly nonlinear TFR such as Ensemble Interval Histogram.

Referring still to the embodiment of FIG. 7, the DSP data analysis process (720) may include a phase map representation sub-process (722). Phase map representation relates generally to the occurrence over time of similar events. The phase-map representation sub-process (722) may be effective to detect the presence of low dimensionality in non-linear data and to characterize the nature of local signal dynamics, as well as helping identify temporal relationships between inputs and outputs. The phase map representation sub-process (722) may be activated as soon as the DSP data analysis process (720) begins, and in general need not await completion of the TFR-space transformation sub-process (724). We can generate a phase map by dividing time-series data into a set of highly overlapping frames (similar to the TFR-space transformation). Instead of applying frequency transformation as in the TFR, we simply create an embedded data matrix, where each column holds either raw samples or principal components of the frame data. The resulting structure again is a matrix. Each column vector spans a phase-map vector space, in which we can trace trajectories of the system dynamical behavior over time.

Referring still to the embodiment illustrated in FIG. 7, when the TFR-space transformation sub-process (724) and the phase map representation sub-process (722) complete, they may call a detection/clustering sub-process (726), which also operates on the preprocessed data of magnitude with respect to time. It may be desirable in an embodiment to calculate intensity in TFR space. In an embodiment of the DSP data mining program (700) that includes the detection/clustering sub-process (726), phase map-space may be divided into tiles. The number of hits per tile may then be tabulated by calculating how many of the observations fall within the boundaries of each tile in phase-map space. Tiles for which the count exceeds a detection threshold may then be grouped spatially into clusters, thereby facilitating the compact description of tiles with the concept of fractal dimension. In one embodiment that detection threshold may be predetermined. In another embodiment that detection threshold may be computed dynamically based on the characteristics and performance of the data in the detection/clustering sub-process (726). In still another embodiment, phase-map space clustering may be based on an expectation-maximization algorithm. When the detection/clustering sub-process (726) ends, the DSP data analysis process (720) has finished.

Referring still to the exemplary embodiment illustrated in FIG. 7, when the DSP data analysis process (720) ends, it calls a DSP feature extraction process (730). The DSP feature extraction process (730) may perform functions to evaluate features of the time frequency representation. The actual distribution of clusters may provide insight into how significant events are distributed over time in a TFR space and when similar events occur in time in the phase map representation. Local features may be extracted from each cluster or frame and global features from the entire distribution of clusters. The local-feature set encompasses geometric shape-related features (for example, a horizontal line in the TFR space and a diagonal tile structure in the phase-map space would indicate a sinusoidal event), local dynamics estimated from the corresponding phase-map space, and LPC features from the corresponding time-series segment. The global-feature set may include the overall time-frequency distribution in TFR-space and the hidden Markov model that represents the cluster distribution in a phase map representation.

In the embodiment of FIG. 7, when the DSP feature extraction process (730) ends it calls the DSP algorithm selection process (740). The DSP algorithm selection process (740) may select an appropriate subset of DSP algorithms from an algorithm library as a function of the local and global features. Actual selection may be based on a knowledge database that keeps track of which DSP algorithms work best given the global-feature and local-feature distribution. The objective function for selecting the best algorithm given the input features is based on how well features derived from each DSP transformation algorithm achieve energy compaction and discriminate output classes. For example, if the local features indicate the presence of a sinusoidal event as indicated by a long horizontal line in the TFR space, the Fourier transform may be the optimal choice. On the other hand, if the local features imply the presence of exponentially damped sinusoids, the Gabor transform may be invoked. The Hough transform may be useful for identifying line-like structures of arbitrary orientation in images. A one-dimensional discrete cosine transform (DCT) is appropriate for identifying vertical or horizontal line-like structures (in particular, sonar grams in passive narrow-band processing) in images. Two-dimensional DCT or wavelets may be useful for identifying major trends. Viterbi algorithms may be useful for identifying wavy-line structures. Meta features may also be extracted that describe raw data, much like meta features that describe features, and that can shed insights into appropriate DSP and/or IP algorithms.

Referring still to the embodiment of FIG. 7, when the DSP algorithm selection process ends it calls a DSP algorithm evaluation process (750). The DSP algorithm evaluation process (750) is one embodiment of the more general algorithm evaluation process (150) described above in reference to FIG. 1. The DSP algorithm evaluation process (750) evaluates the DSP algorithm selected by the DSP algorithm selection process (740). The DSP algorithm evaluation process (750) bases its evaluation on energy compaction and discrimination/correlation capabilities. The DSP algorithm evaluation process may also update a knowledge database used by the DSP algorithm selection process (740). When the DSP algorithm evaluation process (750) ends, the DSP data mapping program (700) has completed.

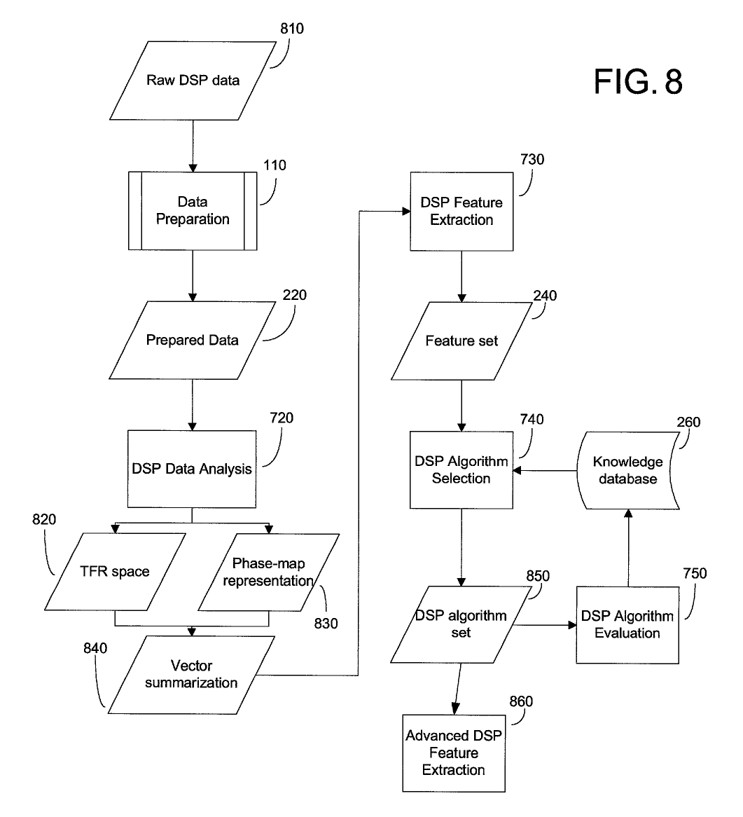

Referring now to FIG. 8, there is disclosed a data flowchart that depicts generally the path of data and the processing steps for a specific example of automatic mapping of DSP data to a processing algorithm. The data begins in the form of raw DSP data (810), which is time-series data. This data may reside in an existing database, or may be collected using sensors, or may be keyed in by the user to capture it in a suitable machine-readable form. The raw DSP data (810) flows to and is operated on by the data preparation process (110), which may function to smooth, fill, transform, and normalize the data resulting in prepared data (220). The prepared data (220) next flows to and is operated on by a DSP data analysis process (720). The DSP data analysis process (720) may perform the function of TFR-space transformation to produce TFR-space data (820). The DSP data analysis process (720) may also perform the function of phase map representation to produce phase-map representation data (830). The DSP data analysis process (720) may also use TFR-space data (820) and phase map representation data (830) to perform the function of detection/clustering to produce vector summarization data (840). In general, the output is summarized in a vector. In storm image analysis for example, each storm cell is summarized in a vector of spatial centroid, time stamp, shape statistics, intensity statistics, gradient, boundary, and so forth. The TFR-space data (820), phase map representation data (830), and vector summarization data (840) next flow to and are operated on by the DSP feature extraction process (730) to produce feature set data (240). The feature set data (240) next flows to and is operated on by the DSP algorithm selection process (740), which uses the knowledge database (260) to select a set of DSP algorithms that are then included in DSP algorithm set data (850). The DSP algorithm set data (850) next flows to and is operated on by the DSP algorithm evaluation process (750), which in turn updates the knowledge database (260). After selection of advanced DSP algorithms from the knowledge database, control passes to an advanced DSP feature extraction process (860) where advanced DSP features are extracted and appended to the original feature set. The final results are, first, the DSP algorithm set data (850), second, the updated knowledge database (260), and third the composite feature set derived from both basic and advanced DSP algorithms.

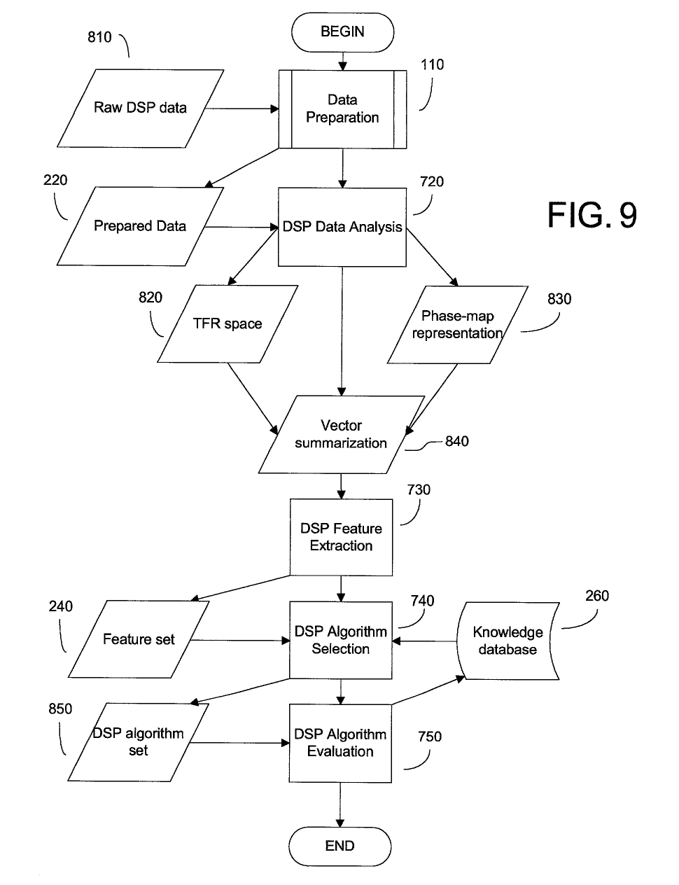

Referring now to FIG. 9, there is shown a system flowchart that generally depicts the flow of operations and data flow of an example of a system for automatic mapping of DSP data to a processing algorithm. The individual data symbols, indicating the existence of data, and process symbols, indicating the operations to be performed on data, are as described in connection with FIG. 7 above and FIG. 8 above. When it begins, the program control initially passes to the data preparation process (110). This process operates on raw DSP data (810) to produce prepared data (220), then when it is finished passes control to the DSP data analysis process (720). The DSP data analysis process (720) operates on prepared data (220) to produce TFR-space data (820) phase map representation data (830) and vector histogram data (840), then when it is finished passes control to the DSP feature extraction process (730). The DSP feature extraction process (730) operates on TFR-space data (820), phase map representation data (830), and vector histogram data (840), to produce feature set data (240), then when it is finished passes control to the DSP algorithm selection process (740). The DSP algorithm selection process (740) uses the algorithm knowledge database (260) and operates on the feature set data (240) to produce DSP algorithm set data (850), then when it is finished passes control to the DSP algorithm evaluation process (750). The DSP algorithm evaluation process (750) evaluates the DSP algorithm set data (850), then uses the results of its evaluation to update the algorithm knowledge database (260). After the DSP algorithm evaluation process (750) completes, the program may end.

Referring now to FIG. 10, there is disclosed a program flowchart of one embodiment of an IP data mapping program (1000). When the IP data mapping program begins control starts with a data preparation process (110) to perform simple functions such as conditioning/preprocessing, CFAR processing, or adaptive integration. This data preparation process (110) may fill, smooth, transform, and normalize DSP data. When the data preparation process (110) has completed, it calls an IP data analysis process (1020). This IP data analysis process (1020) is one embodiment of a general data analysis process (120) described above in connection with FIG. 1.

Referring still to the embodiment of FIG. 10, the IP data analysis process (1020) may include a detection/segmentation sub-process (1023) and a region of interest (“ROI”) shape characterization sub-process (1026). The detection/segmentation sub-process (1023) detects and segments the ROI. A detector first looks for certain intensity patterns such as bright pixels followed by dark ones in underwater imaging applications. After detection, any pixel that meets the detection criteria will be marked to be considered for segmentation. Next, spatially similar marked pixels are clustered to generate clusters to be processed later through feature extraction and data mining. The ROI shape characterization sub-process (1026) then identifies local shape-related and intensity-related characteristics of each ROI. In addition, the ROI shape characterization sub-process (1026) may identify two-dimensional wavelets to characterize texture. Two-dimensional wavelets divide an image in terms of frequency characteristics in both spatial dimensions. Shape-related features encompass statistics associated with edges, wavelet coefficients, and the level of symmetry. Intensity-related features may include mean, variance, skewness, kurtosis, gradient in radial directions from the centroid, and others. When the detection/segmentation sub-process (1023) and the ROI shape characterization sub-process (1026) complete, the IP data analysis process (1020) may also terminate.

In the example of FIG. 10, when the IP data analysis process (1020) terminates, control passes to a ROI feature extraction process (1030). The ROI feature extraction process (1030) extracts global features from each image that characterizes the nature of all ROI snippets identified as clusters. The ROI feature extraction process (1030) also extracts local shape-related features, intensity-related features, and other local features from each ROI. When the ROI feature extraction process (1030) terminates, control passes to an IP algorithm selection process (1040). The IP algorithm selection process (1040) selects an appropriate subset of IP algorithms from an algorithm library as a function of the local and global features. The actual selection is based on a knowledge database that keeps track of which IP algorithms work best given the global-feature and local-feature distribution. The objective function for selecting the best algorithm given the input features is based on how well features derived from each IP transformation algorithm achieve energy compaction and discriminate output classes.

Referring still to the example of FIG. 10, when the IP algorithm selection process (1040) terminates, control passes to an IP algorithm evaluation process (1050). The IP algorithm evaluation process (1050) is an embodiment of the more general algorithm evaluation process (150) described above in reference to FIG. 1. The IP algorithm evaluation process (1050) evaluates the IP algorithm selected by the IP algorithm selection process (1040). The IP algorithm evaluation process (1050) of the illustrated embodiment bases its evaluation on energy compaction and discrimination capabilities. The IP algorithm evaluation process may also update a knowledge database used by the ISP algorithm selection process (1040). When the IP algorithm evaluation process (1050) ends, the IP data mapping program (1000) has completed.

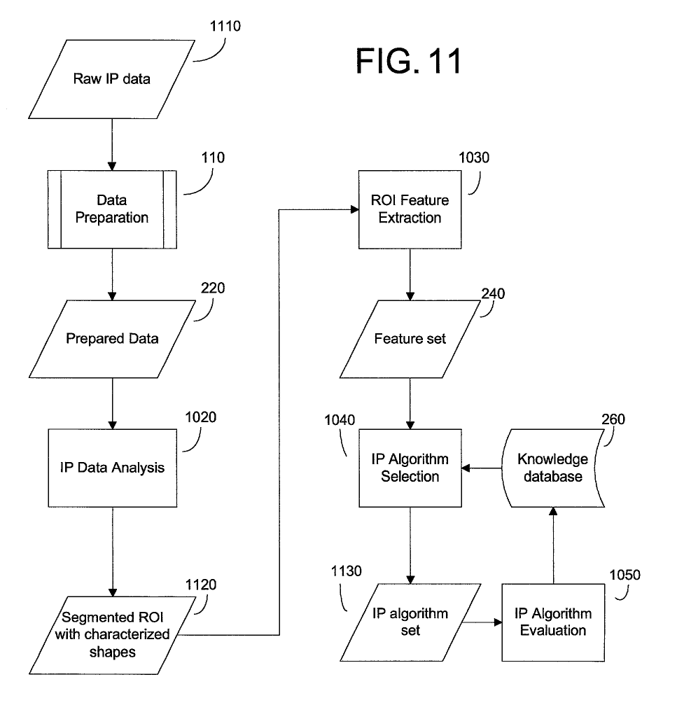

Referring now to FIG. 11, there is disclosed a data flowchart that generally depicts the path of data and the processing steps for a specific example of automatic mapping of IP data to an appropriate IP processing algorithm. The data begins in the form of raw IP data (1110). This data may reside in an existing database, or may be collected using spatial sensors, or may be keyed in by the user to capture it in a suitable machine-readable form. Under certain conditions, spatial sensors such as radar, sonar, infrared, and the like will require some preliminary processing to convert time-series data into IP data. The raw IP data (1110) flows to and is operated on by the data preparation process (110), which may function to smooth, fill, transform, and normalize the data resulting in prepared data (220). The prepared data (220) next flows to and is operated on by an IP data analysis process (1020).

The IP data analysis process (1020) in the embodiment of FIG. 11 may perform the functions detection/segmentation and ROI space characterization to produce segmented ROI with characterized shapes data (1120). First, after preprocessing (cleaning and integration), all the pixels that are unusually bright or dark in comparison to the neighboring pixels are detected as a form of CFAR processing. Second, detected pixels are spatially clustered to segment each ROI. From each ROI, features are extracted to describe shape, intensity, texture, and gradient. The resulting data should be in the form of a matrix, where each column represents features associated with each detected cluster. The segmented ROI with characterized shapes data (1120) next flows to and is operated on by the IP feature extraction process (730) to produce feature set data (240). The feature set data (240) next flows to and is operated on by the IP algorithm selection process (1040), which uses the knowledge database (260) to select a set of IP algorithms that are then included in IP algorithm set data (1130). The IP algorithm set data (1130) next flows to and is operated on by the IP algorithm evaluation process (1050), which in turn updates the knowledge database (260). The final results are, first, the IP algorithm set data (1150) and, second, the updated knowledge database (260).

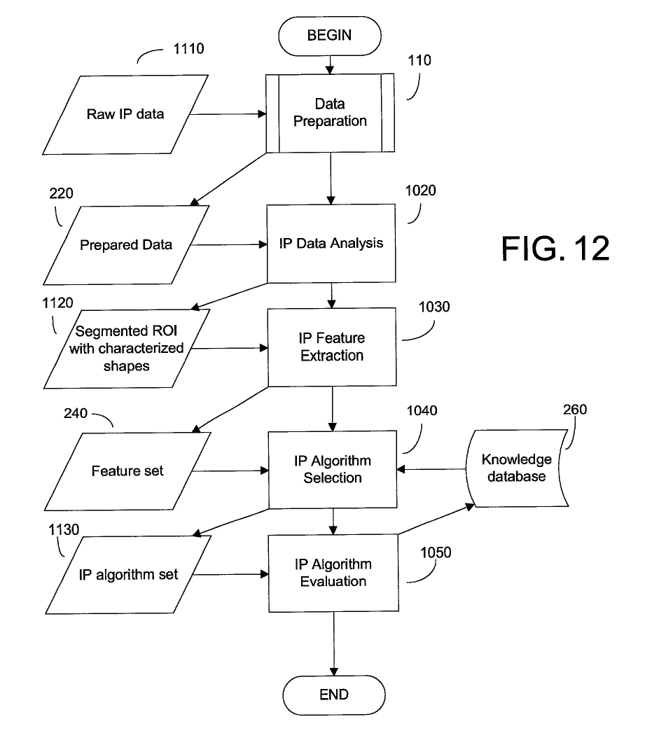

Referring now to FIG. 12, there is shown a system flowchart that generally depicts the flow of operations and data flow of a specific example of a system for automatic mapping of raw IP data (1110) to IP algorithm set data (1130) identifying relevant IP preprocessing algorithms. The individual data symbols, indicating the existence of data, and process symbols, indicating the operations to be performed on data, are as described in connection with FIG. 10 above and FIG. 11 above. When it begins, the program control initially passes to the data preparation process (110). This process operates on raw IP data (1110) to produce prepared data (220), then when it is finished passes control to the IP data analysis process (1020). The IP data analysis process (1020) operates on prepared data (220) to produce segmented ROI with characterized shapes data (1120), then when it is finished passes control to the IP feature extraction process (1030). The IP feature extraction process (1030) operates on segmented ROI with characterized shapes data (1120), to produce feature set data (240), then when it is finished passes control to the IP algorithm selection process (1040). The IP algorithm selection process (1040) uses the algorithm knowledge database (260) and operates on the feature set data (240) to produce IP algorithm set data (1130), then when it is finished passes control to the IP algorithm evaluation process (1050). The IP algorithm evaluation process (1050) evaluates the IP algorithm set data (1050), and then uses the results of its evaluation to update the algorithm knowledge database (260). Moreover, advanced IP features are extracted to provide more accurate description of the underlying image data. The advanced IP features will be appended to the original feature set. After the IP algorithm evaluation process (1050) completes, the program may end.

In one embodiment the particular processes described above may be made, used, sold, and otherwise practiced as articles of manufacture as one or more modules, each of which is a computer program in source code or object code and embodied in a computer readable medium. Such a medium may be, for example, floppy disks or CD-ROMS. Such an article of manufacture may also be formed by installing software on a general purpose computer, whether installed from removable media such as a floppy disk or by means of a communication channel such as a network connection or by any other means.

While the present invention has been described in the context of particular exemplary data structures, processes, and systems, those of ordinary skill in the art will appreciate that the processes of the present invention are capable of being distributed in the form of a computer readable medium of instructions and a variety of forms and that the present invention applies equally regardless of the particular type of signal bearing computer readable media actually used to carry out the distribution. Examples of computer readable media include recordable-type media such as floppy disc, a hard disk drive, a RAM, CD-ROMs, DVD-ROMs, an online internet web site, tape storage, and compact flash storage, and transmission-type media such as digital and analog communications links, and any other volatile or non-volatile mass storage system readable by the computer. The computer readable medium includes cooperating or interconnected computer readable media, which exist exclusively on single computer system or are distributed among multiple interconnected computer systems that may be local or remote. Those skilled in the art will also recognize many other configurations of these and similar components which can also comprise computer system, which are considered equivalent and are intended to be encompassed within the scope of the claims herein.

Although embodiments have been shown and described, it is to be understood that various modifications and substitutions, as well as rearrangements of parts and components, can be made by those skilled in the art, without departing from the normal spirit and scope of this invention. Having thus described the invention in detail by way of reference to preferred embodiments thereof, it will be apparent that other modifications and variations are possible without departing from the scope of the invention defined in the appended claims. Therefore, the spirit and scope of the appended claims should not be limited to the description of the embodiments contained herein. The appended claims are contemplated to cover the present invention and any and all modifications, variations, or equivalents that fall within the true spirit and scope of the basic underlying principles disclosed and claimed herein.

1. A method to identify a preprocessing algorithm for raw data, the method comprising:
providing an algorithm knowledge database including preprocessing algorithm data and feature set data associated with the preprocessing algorithm data;
analyzing raw data to produce analyzed data;
extracting from the analyzed data features that characterize the data;
selecting a preprocessing algorithm using the algorithm knowledge database and features extracted from the analyzed data.

2. The method of claim 1 wherein the raw data comprises at least member selected from a group consisting of DSP data and IP data.

3. The method of claim 2 wherein:
if the raw data comprises DSP data then the raw data is analyzed using at least one process selected from a group consisting or TFR-space transformation, phase map representation, and detection/clustering, and
if the raw data comprises IP data then the raw data is analyzed using at least one process selected from a group consisting of detection/segmentation and region of interest shape characterization.

4. The method of claim 1 further comprising at least one member selected from a group consisting of
data preparation and
evaluating the selected preprocessing algorithm.

5. The method of claim 4 wherein the data preparation includes at least one member selected from a group consisting of conditioning/preprocessing, constant false alarm rate processing, and adaptive integration.

6. The method of claim 5 wherein the conditioning/preprocessing includes at least one member selected from a group consisting of interpolation, transformation, normalization, hardlimiting outliers, and softlimiting outliers.

7. The method of claim 4 further comprising the step of updating the algorithm knowledge base after evaluating the selected preprocessing algorithm.

8. A data mining system for identifying a preprocessing algorithm for raw data comprising:
at least one memory containing an algorithm knowledge database and raw data for processing;
random access memory having stored therein a computer program and which is coupled to the at least one memory such that the random access memory is adapted to receive:
at least one data analysis program to analyze raw data,
a feature extraction program to extract features from raw data, and
an algorithm selection program to identify a preprocessing algorithm.

9. The data mining system of claim 8 wherein the algorithm knowledge database and the raw data for processing are contained in a plurality of memories.

10. The data mining system of claim 8 wherein the data analysis program includes at least one member selected from a group consisting of a DSP data analysis program and an IP data analysis program.

11. The data mining system of claim 10 where
the DSP data analysis program is able to perform at least one subprogram selected from a group consisting of TFR-space transformation, phase map representation, and detection/clustering, and
the IP data analysis program is able to perform at least one subprogram selected from a group consisting of detection/segmentation and region of interest shape characterization.

12. The data mining system of claim 8 wherein the random access memory is also adapted to receive at least one member selected from a group consisting of a data preparation subprogram and an algorithm evaluation subprogram.

13. The data mining system of claim 12 wherein the data preparation program includes at least one member selected from a group consisting of a conditioning/preprocessing subprogram, a constant false alarm rate processing subprogram, and an adaptive integration subprogram.

14. The data mining system of claim 13 wherein the conditioning/preprocessing subprogram includes at least one member selected from a group that includes interpolation, transformation, normalization, hardlimiting outliers, and softlimiting outliers.

15. The data mining system of claim 12 wherein the algorithm evaluation program updates the algorithm knowledge database on the first storage device.

16. A data mining system for identify a preprocessing algorithm for raw data, the data mining system comprising
a means for storing an algorithm knowledge database,
a means for storing raw data;
a means for data analysis on the raw data to produce analyzed data;
a means for feature extraction from the analyzed data to produce a feature set;
a means for algorithm selection using the feature set and the algorithm knowledge database.

17. The data mining system of claim 16 wherein the means for data analysis is selected from a group consisting of a means for DSP data analysis and a means for IP data analysis.

18. The data mining system of claim 17 wherein
the means for DSP data analysis includes at least one member selected from a group consisting of a means for TFR-space transformation, a means for phase-map representation, and a means for detection/clustering, and
the means for IP data analysis includes at least one member selected from a group consisting of a means for detection/segmentation and a means for region of interest shape characterization

19. The data mining system of claim 16 further comprising at least one member of a group consisting of:
a means for algorithm evaluation whereby the data mining system updates the algorithm knowledge database; and
a means for data preparation that converts the raw data into prepared data, wherein the means for data analysis operates on the raw data after it has been converted into the prepared data.

20. The data mining system of claim 19 wherein the means for data preparation includes at least one member selected from a group consisting of a means for conditioning/preprocessing of the raw data, a means for constant false alarm rate processing of the raw data, and a means for adaptive integration of the raw data.

21. The data mining system of claim 20 wherein the means for conditioning/preprocessing includes at least one member selected from a group consisting of a means for interpolation, a means for transformation, a means for normalization, a means for hardlimiting outliers, and a means for soft limiting outliers.

22. A data mining application comprising:
a) an algorithm knowledge database including preprocessing algorithm data and feature set data associated with the preprocessing algorithm data;
b) a data analysis module that is adapted to receive control of the data mining application when the data mining application begins;
c) a feature extraction module that is adapted to receive control of the data mining application from the data analysis module and that is available to identify a set of features; and
d) an algorithm selection module that is adapted to receive control from the feature extraction module and that is adapted to identify a preprocessing algorithm based upon the set of features identified by the feature extraction module using the algorithm knowledge database.

23. The data mining application of claim 22 wherein the algorithm selection module selects an algorithm from a group consisting of at least one DSP algorithm and at least one IP algorithm.

24. The data mining application of claim 23 wherein the algorithm selection module selects an algorithm using at least one member selected from a group consisting of energy compaction capabilities, discrimination capabilities, correlation capabilities.

25. The data mining application of claim 23 wherein
the algorithm selection module selects the at least one DSP algorithm if and only if the data analysis module uses at least one member of a group consisting of a short-time Fourier transform coupled with linear predictive coding analysis, a compressed phase-map representation, and a detection/clustering process; or
the algorithm selection module selects the at least one IP algorithm if and only if the data analysis module uses at least one member of a group consisting a procedure operable to provide at least one a region of interest by segmentation, a procedure to extract local shape related features from a region of interest; a procedure to extract two-dimensional wavelet features characterizing a region of interest; and a procedure to extract global features characterizing all regions of interest

26. The data mining application of claim 25 wherein the detection/clustering process includes at least one member selected from a group consisting of (a) an expectation maximization algorithm and (b) procedures that perform operations of setting a hit detection threshold, identifying phase-space map tiles, counting hits in each identified phase-space map tile, and detecting the phase-space map tiles for which the hits counted exceeds the hit detection threshold.

27. The data mining application of claim 22 further comprising at least one member of a group consisting of:
an advanced feature extraction module available to receive control from the algorithm selection module and to identify more features for inclusion in the set of features;
a data preparation module that is available to receive control after the data mining application begins, wherein the data analysis module is available to receive control from the data preparation module; and
an algorithm evaluation module that evaluates performance of the preprocessing algorithm identified by the algorithm selection module and updates the algorithm knowledge database.

28. The data mining application of claim 27 wherein the data preparation module includes at least one member selected from a group consisting of a conditioning/preprocessing process, a constant false alarm rate processing process to identify and extract long term trend lines, and an adaptive integration process.

29. The data mining application of claim 28 wherein
the conditioning/preprocessing process includes at last one member selected from a group consisting of interpolation, transformation, normalization, hardlimiting outliers, and softlimiting outliers; and
the adaptive integration includes at least one member selected from a group consisting of subspace filtering and kernel smoothing.

30. A data mining product embedded in a computer readable medium, comprising:
at least one computer readable medium having an algorithm knowledge database embedded therein and having a computer readable program code embedded therein to identify a preprocessing algorithm for raw data, the computer readable program code in the computer program product comprising:
computer readable program code for data analysis to produce analyzed data from the raw data;
computer readable program code for feature extraction to identify a feature set from the analyzed data; and
computer readable program code for algorithm selection to identify a preprocessing algorithm using the analyzed data and the algorithm knowledge database.

31. The data mining product of claim 30 wherein the data mining product is embedded in a plurality of computer readable media.

32. The data mining product of claim 30 wherein the computer readable program code for data analysis includes at least one member selected from a group consisting of computer readable program code for DSP data analysis and computer readable program code for IP data analysis.

33. The data mining product of claim 32 wherein
the computer readable program code for DSP data analysis includes at least one member of a group consisting of computer readable program code for TFR-space transformation, computer readable program code for phase map representation and computer readable program code for detection/clustering, and
the computer readable program code for IP data analysis includes at least one member of a group consisting of computer readable program code for detection/segmentation, and computer readable program code for region of interest shape characterization.

34. The data mining product of claim 30 further comprising at least one member selected from the group consisting of
computer readable program code for data preparation to produce prepared data from the raw data, wherein the computer readable program code for data analysis operates on the raw data after it has been transformed into the prepared data; and
computer readable program code for algorithm evaluation to evaluate the preprocessing algorithm selected by the computer readable program code for algorithm selection.

35. The data mining product of claim 34 wherein the computer readable program code for algorithm evaluation is operable to modify the algorithm knowledge database.

36. The data mining product of claim 34 wherein the computer readable program code for data preparation includes at least one member from a group consisting of computer readable program code for conditioning/preprocessing, computer readable program code for constant false alarm rate processing, and computer readable program code for adaptive integration.

37. The computer program product of claim 36 wherein the computer readable program code for conditioning/preprocessing includes at least one member selected from a group consisting of computer readable program code for interpolation, computer readable program code for transformation, computer readable program code for normalization, computer readable program code for hardlimiting outliers, and computer readable program code for softlimiting outliers.
